(19) United States
(12) Patent Application Publication
(10) Pub. No.: US 2026/0301498 A1
(43) Pub. Date: Oct. 1, 2026

(54) TECHNOLOGIES FOR GENERATING A SIMULATED POLL TAPE

(71) Applicant: BallotIQ LLC, Ann Arbor, MI (US)

(72) Inventors: John Alexander Halderman, Ann Arbor, MI (US); Braden L. Crimmins, Ann Arbor, MI (US); Bradley Sturt, Urbana, IL (US)

(21) Appl. No.: 19/092,425

(22) Filed: Mar. 27, 2025

(51) Int. Cl. G07C 13/00

(52) U.S. Cl. CPC G07C 13/00

(57) ABSTRACT

Technologies for generating a simulated poll tape for efficient verification of the operation of a voting machine include a computing system. The computing system includes a processor that is configured to obtain sample ballot data indicative of an image of a ballot to be utilized in an election, determine a style of the ballot based on the sample ballot data, and identify a corresponding voting machine as a function of voting machine indicia data associated with the style of the ballot. Additionally, the processor may be configured to generate a test deck that includes a set of test ballots to be scanned by the identified voting machine, simulate operation of the identified voting machine to analyze votes represented in the generated test deck, and produce a simulated poll tape as a function of the simulated operation of the identified voting machine on the generated test deck.

### BACKGROUND

A multiplicity of different types of voting machines are presently used in political elections. Each voting machine produces an idiosyncratic poll tape to indicate the results of a process of totaling votes detected by the voting machine. That is, visual characteristics of a poll tape produced by one type of voting machine may differ from the visual characteristics of a poll tape from another type of voting machine, even when the underling vote data is the same. Further complexity is added because local rules associated with a given election may impact the types of information to be tracked and/or represented on the poll tape produced by a given voting machine. Presently, verifying the operation of a voting machine requires a resource intensive and error prone process of reviewing a chart of potentially thousands of easily-confused input values that were provided to the voting machine on a set of ballots and determining whether the voting machine produced, in its idiosyncratic format, a poll tape with numbers that accurately reflect totals that should have been calculated from the input values represented in the chart.

### SUMMARY

One embodiment is directed to a unique system, components, and methods for simulating the operation of a voting machine to produce a simulated poll tape that enables efficient verification of the operation of a physical version of the voting machine. Other embodiments are directed to apparatuses, systems, devices, hardware, methods, and combinations thereof for producing a simulated poll tape.

According to an embodiment, a method for producing a simulated poll tape for efficient verification of operation of a voting machine includes obtaining, by a voting machine simulation device, sample ballot data that is indicative of an image of a ballot to be utilized in an election. The method may also include determining, by the voting machine simulation device, a style of the ballot based on the sample ballot data. Performing the determination of the style may include identifying sections of the ballot, contests represented in the ballot, and candidates in each contest. Further, performing the determination of the style may include determining voting machine indicia data as a function of visual characteristics of the ballot, including one or more of a shape of a voting target on the ballot and a location of a timing mark on the ballot. The voting machine indicia data is indicative of a corresponding voting machine to be used with the ballot. The method may also include identifying, by the voting machine simulation device, a corresponding voting machine as a function of the determined voting machine indicia data. The identification may include identifying a corresponding format of a poll tape produced by the corresponding voting machine. Additionally, the method may include generating, by the voting machine simulation device, a test deck that includes a set of test ballots to be scanned by the identified voting machine. Further, the method may include simulating, by the voting machine simulation device, operation of the identified voting machine to analyze votes represented in the generated test deck. The method may also include producing, by the voting machine simulation device, a simulated poll tape as a function of the simulated operation of the identified voting machine on the generated test deck. The simulated poll tape has an appearance of a poll tape produced by a physical version of the identified voting machine and enables efficient visual comparison to determine whether operation of the physical version of the identified voting machine has not been compromised.

In some embodiments, obtaining sample ballot data includes obtaining sample ballot data that is indicative of images of multiple ballots to be used in corresponding districts. Each ballot may have a different style. Further, determining the style may include determining the corresponding style of each of the multiple ballots.

In some embodiments, the method may additionally include determining a structure of the obtained sample ballot data based on non-image data embedded in the sample ballot data. The determination may include determining one or more tags indicative of one or more corresponding properties of elements to be rendered in the corresponding ballot and identifying the sections of the ballot as a function of one or more of font sizes, line widths, or shading represented in the ballot. The method may further include storing data indicative of the structure and properties of the ballot in a JavaScript Object Notation format.

In some embodiments, determining the voting machine indicia data as a function of visual characteristics of the ballot further includes determining the voting machine indicia as a function of an ellipticity of each of multiple voting targets of the ballot. Additionally, identifying the corresponding voting machine as a function of the determined voting machine indicia data may include determining a corresponding manufacturer and model of the voting machine by comparing the voting machine indicia data to reference data that associates voting machine indicia to a set of voting machine manufacturers and models. Further, determining a corresponding format of the poll tape produced by the determined manufacturer and model of the voting machine may include selecting a corresponding poll tape template associated with the determined manufacturer and model.

In some embodiments, the sample ballot data represents multiple ballots and determining the stye includes determining a corresponding style for each of the multiple ballots. Further, generating the test deck may include generating the test deck as a function of each determined style, including placing markings at two-dimensional coordinates on the test ballots as a function of the determined structure and properties associated with the corresponding style. The method may also include selectively adding stray marks to one or more of the test ballots as a function of applicable local rules for testing voting machines. Further, the method may include selectively populating one or more write-in sections as a function of the local rules for testing voting machines and applying an optimization to minimize a number of test ballots in the test deck while enabling testing for a defined set of potential errors.

In some embodiments, the method may additionally include producing a test chart indicative of a plan for a test of the corresponding voting machine.

In some embodiments, simulating operation of the identified voting machine to analyze the votes represented in the generated test deck includes identifying marks on each test ballot in the test deck. The method may also include attributing the marks to the corresponding candidates for each contest as a function of the determined style, selectively applying straight party voting rules in response to a determination that a straight party option is marked on one or more of the test ballots, determining whether a contest is overvoted as a function of a maximum number of votes allowed and a number of votes counted on the test ballots and selectively recording an overvote condition in response to a determination that a contest is overvoted, determining a presence of an undervote condition indicative of fewer than an allowed number of votes for a contest and selectively recording an undervote condition in response to a determination that a contest is undervoted. Further, the method may include tracking a number of write-ins represented in the test deck, tracking names that appear in each write-in section in the test deck, selectively applying de-rotation to account for rotation in an order of candidate names, selectively tracking subtotals associated with one or more parts of a test, and determining a grand total of votes represented in the test deck.

In some embodiments, producing the simulated poll tape includes producing a simulated poll tape that is formatted according to a template associated with the identified voting machine. The method may further include indicating, in the poll tape, totals of votes associated with the contests represented in the ballot, and one or more of a presence of an overvote condition, a presence of an undervote condition, a write-in, or one or more subtotals.

In some embodiments, the sample ballot data is indicative of multiple ballots having different styles. Further, the method may additionally include determining the corresponding style of each of the multiple ballots and producing the simulated poll tape for each of multiple determined styles of ballots.

In some embodiments, the template includes hyper text markup language and cascading style sheets. The method may further include rendering the simulated poll tape with a web browser rendering engine.

In some embodiments, the method may additionally include providing the rendered simulated poll tape to a user computing device to facilitate verification of operation of the physical version of the identified voting machine.

In some embodiments, the method may also include converting the rendered simulated poll tape to a portable document format.

According to another embodiment, a computing system for producing a simulated poll tape for efficient verification of operation of a voting machine includes at least one processor and at least one memory. The memory may include a plurality of instructions stored thereon that, in response to execution by the at least one processor, cause the computing system to obtain sample ballot data. The sample ballot data may be indicative of an image of a ballot to be utilized in an election. The instructions may additionally cause the computing system to determine a style of the ballot based on the sample ballot data. Determining the style of the ballot may include identifying sections of the ballot, contests represented in the ballot, and candidates in each contest. Further, determining the style of the ballot may include determining voting machine indicia data as a function of visual characteristics of the ballot, including one or more of a shape of a voting target on the ballot and a location of a timing mark on the ballot. The voting machine indicia data may be indicative of a corresponding voting machine to be used with the ballot. The instructions may further cause the computing system to identify a corresponding voting machine as a function of the determined voting machine indicia data. Identifying the corresponding voting machine may include identifying a corresponding format of a poll tape produced by the corresponding voting machine. The instructions may also cause the computing system to generate a test deck that includes a set of test ballots to be scanned by the identified voting machine. Further, the instructions may cause the computing system to simulate operation of the identified voting machine to analyze votes represented in the generated test deck. Additionally, the instructions may cause the computing system to produce a simulated poll tape as a function of the simulated operation of the identified voting machine on the generated test deck. The simulated poll tape has an appearance of a poll tape produced by a physical version of the identified voting machine and enables efficient visual comparison to determine whether operation of the physical version of the identified voting machine has not been compromised.

In some embodiments, the processor may be further configured to obtain sample ballot data that is indicative of images of multiple ballots to be used in corresponding districts. Each ballot may have a different style. Further, determining the style may include determining the corresponding style of each of the multiple ballots.

In some embodiments, the processor may be further configured to determine a structure of the obtained sample ballot data based on non-image data embedded in the sample ballot data. The processor may be further configured to determine one or more tags indicative of one or more corresponding properties of elements to be rendered in the corresponding ballot. The processor may also be configured to identify the sections of the ballot as a function of one or more of font sizes, line widths, or shading represented in the ballot. Additionally, the processor may be configured to store data indicative of the structure and properties of the ballot in a JavaScript Object Notation format.

In some embodiments, the processor may be further configured to determine the voting machine indicia as a function of an ellipticity of each of multiple voting targets of the ballot. Further, the processor may be configured to determine a corresponding manufacturer and model of the voting machine. The processor may do so by comparing the voting machine indicia data to reference data that associates voting machine indicia to a set of voting machine manufacturers and models. Further, the processor may be configured to select a corresponding poll tape template associated with the determined manufacturer and model.

In some embodiments, the sample ballot data may represent multiple ballots and the processor may be further configured to determine a corresponding style for each of the multiple ballots. The processor may be further configured to generate the test deck as a function of each determined style. Generating the test deck may include placing markings at two-dimensional coordinates on the test ballots as a function of the determined structure and properties associated with the corresponding style. The processor may also be configured to selectively add stray marks to one or more of the test ballots as a function of applicable local rules for testing voting machines. Additionally, the processor may be configured to selectively populate one or more write-in sections as a function of the local rules for testing voting machines. Further, the processor may be configured to apply an optimization to minimize a number of test ballots in the test deck while enabling testing for a defined set of potential errors.

In some embodiments, the processor may be further configured to produce a test chart indicative of a plan for a test of the corresponding voting machine.

In some embodiments, the processor may be further configured to identify marks on each test ballot in the test deck. Additionally, the processor may be configured to attribute the marks to the corresponding candidates for each contest, as a function of the determined style. The processor may be further configured to selectively apply straight party voting rules in response to a determination that a straight party option is marked on one or more of the test ballots. Additionally, the processor may be configured to determine whether a contest is overvoted as a function of a maximum number of votes allowed and a number of votes counted on the test ballots. Further, the processor may be configured to selectively record an overvote condition in response to a determination that a contest is overvoted. Additionally, the processor may be configured to determine a presence of an undervote condition indicative of fewer than an allowed number of votes for a contest. Further, the processor may be configured to selectively record an undervote condition in response to a determination that a contest is undervoted. The processor may also be configured to track a number of write-ins represented in the test deck. Further, the processor may be configured to track names that appear in each write-in section in the test deck. Additionally, the processor may be configured to selectively apply de-rotation to account for rotation in an order of candidate names. Further, the processor may be configured to selectively track subtotals associated with one or more parts of a test. Additionally, the processor may be configured to determine a grand total of votes represented in the test deck.

In some embodiments, the processor may be further configured to produce a simulated poll tape. The poll tape may be formatted according to a template associated with the identified voting machine. Further, the processor may be configured to indicate, in the poll tape, totals of votes associated with the contests represented in the ballot. The processor may be further configured to indicate one or more of a presence of an overvote condition, a presence of an undervote condition, a write-in, or one or more subtotals.

In some embodiments, the sample ballot data is indicative of multiple ballots having different styles. The processor may be further configured to determine the corresponding style of each of the multiple ballots. Further, the processor may be configured to produce the simulated poll tape for each of multiple determined styles of ballots.

In some embodiments, the template may include hyper text markup language and cascading style sheets. Further, the processor may be configured to render the simulated poll tape with a web browser rendering engine.

In some embodiments, the processor may be further configured to provide the rendered simulated poll tape to a user computing device to facilitate verification of operation of the physical version of the identified voting machine.

In some embodiments, the processor may be further configured to convert the rendered simulated poll tape to a portable document format.

According to another embodiment, a method for producing a simulated poll tape for efficient verification of operation of a voting machine includes obtaining, by a voting machine simulation device, sample ballot data indicative of an image of a ballot to be utilized in an election or a description of a style of the ballot in a machine readable data format. The method may further include identifying, by the voting machine simulation device, a corresponding voting machine as a function of the sample ballot data, including identifying a corresponding format of a poll tape produced by the corresponding voting machine. The method also may include simulating, by the voting machine simulation device, operation of the voting machine to produce, based on a set of votes represented in a test deck or a test chart, a simulated poll tape, wherein the simulated poll tape has an appearance of a poll tape produced by a physical version of the identified voting machine and enables efficient visual comparison to determine whether operation of the physical version of the identified voting machine has not been compromised.

According to another embodiment, a computing system for producing a simulated poll tape for efficient verification of operation of a voting machine includes at least one processor and at least one memory. The memory may include a plurality of instructions stored thereon that, in response to execution by the at least one processor, cause the computing system to obtain sample ballot data indicative of an image of a ballot to be utilized in an election or a description of a style of the ballot in a machine readable data format. The instructions may further cause the computing system to identify a corresponding voting machine as a function of the sample ballot data, including identifying a corresponding format of a poll tape produced by the corresponding voting machine. Additionally, the instructions may cause the computing system to simulate operation of the voting machine to produce, based on a set of votes represented in a test deck or a test chart, a simulated poll tape, wherein the simulated poll tape has an appearance of a poll tape produced by a physical version of the identified voting machine and enables efficient visual comparison to determine whether operation of the physical version of the identified voting machine has not been compromised.

This summary is not intended to identify key or essential features of the claimed subject matter, nor is it intended to be used as an aid in limiting the scope of the claimed subject matter. Further embodiments, forms, features, and aspects of the present application shall become apparent from the description and figures provided herewith.

### BRIEF DESCRIPTION OF THE DRAWINGS

The concepts described herein are illustrative by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 depicts a simplified block diagram of at least one embodiment of a system for producing a simulated poll tape for efficient verification of the operation of a voting machine;

FIG. 2 is a simplified block diagram of at least one embodiment of a computing device;

FIGS. 3-9 are a simplified flow diagram of at least one embodiment of a method for producing a simulated poll tape to enable efficient verification of the operation of a voting machine;

FIG. 10 is a diagram of a ballot having a style that may be analyzed by the system of FIG. 1;

FIGS. 11-13 are illustrations of embodiments of simulated poll tapes that may be produced to enable efficient verification of the operation of a voting machine; and

FIG. 14 is an illustration of at least one embodiment of a test chart indicative of votes represented in a test deck.

### DETAILED DESCRIPTION

Although the concepts of the present disclosure are susceptible to various modifications and alternative forms, specific embodiments have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. It should be further appreciated that although reference to a “preferred” component or feature may indicate the desirability of a particular component or feature with respect to an embodiment, the disclosure is not so limiting with respect to other embodiments, which may omit such a component or feature. Further, when a particular feature, structure, or characteristic is described in connection with an embodiment, it is submitted that it is within the knowledge of one skilled in the art to implement such feature, structure, or characteristic in connection with other embodiments whether or not explicitly described. Further, particular features, structures, or characteristics may be combined in any suitable combinations and/or sub-combinations in various embodiments.

Additionally, it should be appreciated that items included in a list in the form of “at least one of A, B, and C” can mean (A); (B); (C); (A and B); (B and C); (A and C); or (A, B, and C). Similarly, items listed in the form of “at least one of A, B, or C” can mean (A); (B); (C); (A and B); (B and C); (A and C); or (A, B, and C). Further, with respect to the claims, the use of words and phrases such as “a,” “an,” “at least one,” and/or “at least one portion” should not be interpreted so as to be limiting to only one such element unless specifically stated to the contrary, and the use of phrases such as “at least a portion” and/or “a portion” should be interpreted as encompassing both embodiments including only a portion of such element and embodiments including the entirety of such element unless specifically stated to the contrary.

The disclosed embodiments may, in some cases, be implemented in hardware, firmware, software, or a combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures unless indicated to the contrary. Additionally, the inclusion of a structural or method feature in a particular figure is not meant to imply that such feature is required in all embodiments and, in some embodiments, may not be included or may be combined with other features.

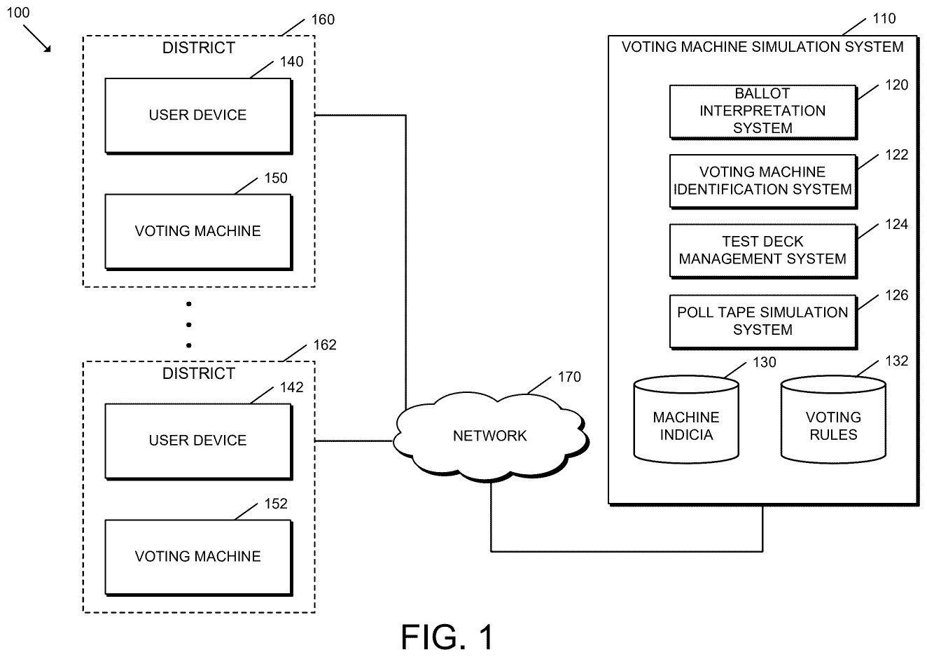

Referring now to FIG. 1, a system 100 (a computing system) for producing a simulated poll tape to enable efficient verification of the operation of a voting machine includes a voting machine simulation system 110, a set of user devices 140, 142, a set of voting machines 150, 152, and a network 170. The user devices 140, 142 and voting machines 150, 152 may be distributed across multiple voting districts 160, 162. The illustrative voting machine simulation system 110 includes a ballot interpretation system 120, a voting machine identification system 122, a test deck management system 124, a poll tape simulation system 126, machine indicia data 130 and voting rules data 132. Although only one ballot interpretation system 120, one voting machine identification system 122, one test deck management system 124, one poll tape simulation system 126, two user devices 140, 142, two voting machines 150, 152, two districts 160, 162, and one network 170 are shown in the illustrative embodiment of FIG. 1, the system 100 may include any number of ballot interpretation systems 120, voting machine identification systems 122, test deck management systems 124, poll tape simulation systems 126, user devices 140, 142, voting machines 150, 152, districts 160, 162, and networks 170. For example, in some embodiments, multiple voting machine simulation systems 110 (e.g., related or unrelated systems) may be used to perform the various functions described herein. Further, in some embodiments, one or more of the systems described herein may be excluded from the system 100, one or more of the systems described as being independent may form a portion of another system, and/or one or more of the systems described as forming a portion of another system may be independent.

The voting machine simulation system 110 may be embodied as any one or more types of devices/systems capable of performing the functions described herein. For example, as described herein, the ballot interpretation system 120 is configured to obtain sample ballot data indicative of one or more ballots to be utilized in an election. That is, the ballot interpretation system 120 is configurable to obtain data indicative of one or more ballots to be printed on physical media, such as paper, with voting targets, such as circles or ovals, to be filled in by voters to indicate corresponding votes and subsequently analyzed by a corresponding voting machine 150, 152 to quantify the votes that were cast. The ballot interpretation system 120 may receive the sample ballot data from one or more of the user devices 140, 142 associated with corresponding elections in corresponding districts 160, 162. Each ballot may have a different style, including a particular structure and properties that correspond with the contests represented on the sample ballots, particular candidates that may be voted on for each contest, political parties associated with the candidates, and formatting elements, referred to herein as voting machine indicia, that are unique to particular makes and models of voting machines 150, 152. The ballot interpretation system 120 analyzes the sample ballot data to identify the style of each sample ballot as described in more detail herein.

The voting machine identification system 122 may analyze the voting machine indicia represented on each sample ballot in the sample ballot data to identify which voting machine 150, 152 the ballots are to be used with. In doing so, the voting machine identification system 122 may analyze visual features such as the shape of the voting targets (e.g., the “bubbles”) on a given ballot, the features of the timing marks, and/or style codes represented on the ballot. In analyzing the shapes of voting targets, the voting machine identification system 122 may determine whether the shapes are elliptical or otherwise (e.g., rectangular). Further, if the shapes are elliptical, the voting machine identification system 122 may determine an ellipticity of the voting targets. That is, the machine identification system 122 may determine whether the shapes are more circular or more oval in shape, based on a ratio between a major axis and a minor axis, in which the more the ratio diverges from 1:1, the less circular and more ovoidal the voting target is. In analyzing the timing marks, which provide information to a voting machine as to the location of the voting targets, the voting machine identification system 122 may determine the sizes, locations, and shapes of the timing marks. Further, in analyzing the style codes, the voting machine identification system 122 may determine a sequence of one or more symbols, such as letters and/or numbers appearing on a ballot that identify a style associated with the ballot. The voting machine identification system 122 may compare the voting machine indicia to the machine indicia data 130, which may be embodied as a data set of voting machine indicia and associated identifiers (e.g., manufacturers and models) of voting machines. The voting machine identification system 122 may further determine a corresponding template for poll tapes produced by that identified type of voting machine, based on a set of templates associated with the machine indicia data 130. That is, the machine indicia data 130 may include, for each type of voting machine, a corresponding template that is indicative of a format of poll tape produced by that type of voting machine.

The test deck management system 124 may generate a test deck that includes a set of test ballots to be scanned by a voting machine 150, 152 in a test of the operation of the voting machine 150, 152. That is, the test deck management system 124 may produce a set of test ballots with markings at two-dimensional coordinates based on the structure and properties (e.g., the style) of the corresponding sample ballot, such that the markings align with the positions of the voting targets and represent a set of votes that the voting machine 150, 152, if operating correctly, will quantify and represent accurately on a resulting poll tape printed by the voting machine 150, 152. Further, the test deck management system 124, in producing the test deck, may account for local rules, represented in the voting rules data 132 (e.g., associated with the district 160, 162), such as adding stray marks (e.g., marks outside of the voting targets), populating (e.g., entering information into) one or more write-in sections, causing an overvote condition, such as representing more votes than allowed for a given contest, causing an undervote condition, such as representing fewer than the number of allowed votes for a given contest, or other requirements. In some embodiments, the test deck management system 124 may produce a test chart, which may be embodied as a table that indicates which votes are represented in the test deck for each test ballot and totals for the votes. In some embodiments, the test deck management system 124 may apply one or more algorithms to minimize the number of test ballots in a given test deck while providing a sufficient number and distribution of votes to detect one or more potential misconfigurations (e.g., unintentional or otherwise) of the voting machine 150, 152, that would cause the voting machine 150, 152 to incorrectly quantify the votes.

The poll tape simulation system 126 may simulate the operation of the identified voting machine 150, 152 in analyzing the corresponding the test deck and produce a simulated poll tape in the format (e.g., with the template) associated with that identified voting machine 150, 152. In doing so, the poll tape simulation system 126 may identify the marks on each test ballot, attribute the marks to the corresponding candidates for each contest, selectively apply straight party voting rules, determine whether a contest is overvoted, determine whether a contest is undervoted, track write-ins, including the number of write-ins and the content of the write-ins (e.g., the information written into write-in sections), apply de-rotation operations to account for a potential modification of the ordering of candidate names across ballots (e.g., according to local voting rules, represented in the voting rules data 132), selectively track subtotals of votes for particular parts of a verification test (e.g., according to local voting rules, represented in the voting rules data 132), and determine grand totals for the votes (e.g., for each contest). Further, in producing the simulated poll tape, the poll tape simulation system 126 may produce a simulated poll tape that is formatted according to the template associated with the identified voting machine 150, 152.

Further, the poll tape simulation system 126 may indicate, on the simulated poll tape, totals of votes associated with the contests represented in the test deck, potentially including conditions detected in the totaling of the votes, such as overvote conditions or undervote conditions. Further, the poll tape simulation system 126 may indicate write-ins detected in the test deck, including the number and/or content of the write-ins. The poll tape simulation system 126 may produce a simulated poll tape that may represent a subset of the total set of data determined in the analysis of the test deck, based on the particular sets of information that are to be printed on a poll tape in accordance with the local rules that apply to the district 160, 162 and the particular type of voting machine 150, 152 being simulated. The poll tape simulation system 126 may render the simulated poll tape using a headless web browser rendering engine. That is, the poll tape simulation system 126 may utilize a template that is encoded in a hyper text markup language (HTML), potentially including cascading style sheets (CSS), and utilize a rendering engine (e.g., WebKit, Gecko, etc.) to produce a visual representation of the simulated poll tape. Further, the poll tape simulation system 126 may convert the resulting visual representation to another format, such as a file in a portable document format (PDF). Further, the poll tape simulation system 126, in the illustrative embodiment, may combine simulated poll tapes for different styles of ballots and corresponding different types of voting machines into a single visual representation or file (e.g., PDF file). The voting machine simulation system 110 may transmit the resulting simulated poll tape to a corresponding user (e.g., a user of a user device 140, 142), thereby providing a representation of the poll tape as it should appear when printed by the corresponding physical (e.g., actual) voting machine 150, 152 after performing an analysis of the test ballots in the test deck.

Accordingly, the user may quickly perform a visual comparison of the simulated poll tape to the actual poll tape produced by the voting machine 150, 152 and immediately identify any discrepancies indicative of a misconfiguration or other error in the operation of the voting machine 150, 152. As compared to conventional systems, by determining the type of voting machine and producing a simulated poll tape that matches the formatting of a poll tape that would be produced by that voting machine, rather than requiring personnel to compare a chart of potentially thousands of votes in a format that does not match the format of the poll tape, the system 100 vastly decreases the resources and likelihood of error in verifying the operation of voting machines.

In the illustrative embodiment, the machine indicia data 130 and the voting rules data 132 are stored in corresponding cloud-based data stores, such as a combination of relational database and blob storage buckets. However, it should be appreciated that the machine indicia data 130 and the voting rules data 132 may be stored in any type of data storage capable of storing data received by, used by, and/or generated by the voting machine simulation system 110. Further, although the machine indicia data 130 and the voting rules data 132 are represented in FIG. 1 as singular, separate data stores, it should be appreciated that the machine indicia data 130 and voting rules data 132 (or portions thereof) may each be stored in multiple data storages in some embodiments.

Although the voting machine simulation system 110 is described herein in the singular, it should be appreciated that the voting machine simulation system 110 may be embodied as or include multiple servers/systems in some embodiments. Further, although the voting machine simulation system 110 is described herein, in at least some embodiments, as a cloud-based system, it should be appreciated that the voting machine simulation system 110 may be embodied as one or more servers/systems residing outside of a cloud computing environment in other embodiments. In cloud-based embodiments, the voting machine simulation system 110 may be embodied as a server-ambiguous computing solution similar to that described below.

Each of the user devices 140, 142 may be embodied as any type of device or system capable of interacting with the voting machine simulation system 110 (e.g., via a network, using one or more corresponding communication protocols, application programming interface (API) calls, etc.) and/or otherwise capable of performing the functions described herein. It should be appreciated that, in some embodiments, each user device 140, 142 may execute an application to interact with the voting machine simulation system 110, which may be embodied as any type of application suitable for performing the functions described herein. In particular, in some embodiments, the application may be embodied as a mobile application (e.g., a smartphone application), a cloud-based application, a web application, a thin-client application, and/or another type of application. For example, in some embodiments, an application (e.g., executed by a corresponding user device 140, 142) may serve as a client-side interface (e.g., via a web browser) for a web-based application or service (e.g., executed/provided by the voting machine simulation system 110).

The network 170 may be embodied as any one or more types of communication networks that are capable of facilitating communication between the various devices communicatively connected via the network 170 (e.g., the voting machine simulation system 110 and the user devices 140, 142). As such, the network 170 may include one or more networks, routers, switches, access points, hubs, computers, and/or other intervening network devices. For example, the network 170 may be embodied as or otherwise include one or more cellular networks, telephone networks, local or wide area networks, publicly available global networks (e.g., the Internet), ad hoc networks, short-range communication links, or a combination thereof. In some embodiments, the network 170 may include a circuit-switched voice or data network, a packet-switched voice or data network, and/or any other network able to carry voice and/or data. In particular, in some embodiments, the network 170 may include Internet Protocol (IP)-based and/or asynchronous transfer mode (ATM)-based networks. In some embodiments, the network 170 may handle voice traffic (e.g., via a Voice over IP (VOIP) network), web traffic (e.g., such as hypertext transfer protocol (HTTP) traffic and hypertext markup language (HTML) traffic), and/or other network traffic depending on the particular embodiment and/or devices of the system 100 in communication with one another. In various embodiments, the network 170 may include analog or digital wired and wireless networks. For example, the network 170 may include an IEEE 802.11 network, Public Switched Telephone Network (PSTN), Integrated Services Digital Network (ISDN), Digital Subscriber Line (xDSL) network, mobile telecommunications network, wired Ethernet network, private network (e.g., such as an intranet), radio, television, cable, satellite, and/or any other delivery or tunneling mechanism for carrying data, or any appropriate combination of such networks. The network 170 may enable connections between the various devices/systems 110, 120, 122, 124, 126, 140, 142 of the system 100. It should be appreciated that the various devices/systems 110, 120, 122, 124, 126, 140, 142 may communicate with one another via different networks 170 depending on the source and/or destination devices/systems 110, 120, 122, 124, 126, 140, 142.

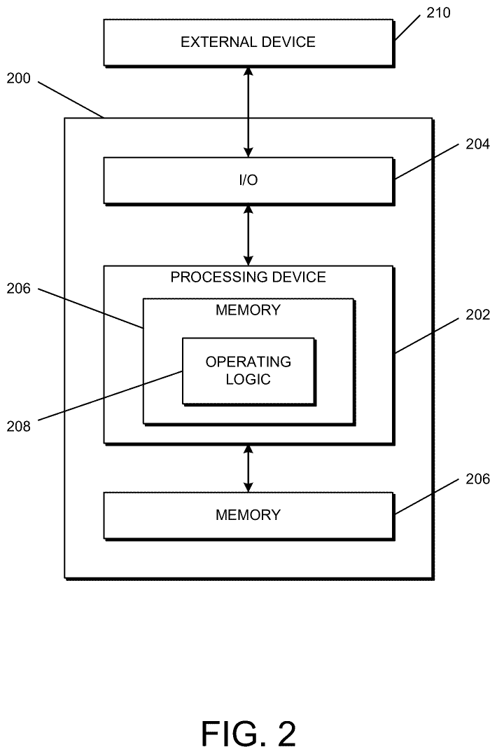

It should be appreciated that each of the voting machine simulation system 110, the data sets 130, 132 and the user devices 140, 142 may be embodied as, executed by, form a portion of, or associated with any type of device/system, collection of devices/systems, and/or portion(s) thereof suitable for performing the functions described herein (e.g., the computing device 200 of FIG. 2).

Referring now to FIG. 2, a simplified block diagram of at least one embodiment of a computing device 200 is shown. The illustrative computing device 200 depicts at least one embodiment of each of the computing devices, machines, systems, servicers, controllers, switches, gateways, engines, modules, and/or computing components described herein (e.g., which collectively may be referred to interchangeably as computing devices, servers, or systems for brevity of the description). In some embodiments, the computing device 200 may be embodied as a server, desktop computer, laptop computer, tablet computer, notebook, netbook, Ultrabook™, cellular phone, mobile computing device, smartphone, wearable computing device, personal digital assistant, Internet of Things (IoT) device, processing system, wireless access point, router, gateway, and/or any other computing, processing, and/or communication device capable of performing the functions described herein.

The computing device 200 includes a processing device 202 that executes algorithms and/or processes data in accordance with operating logic 208, an input/output device 204 that enables communication between the computing device 200 and one or more external devices 210, and memory 206 which stores, for example, data received from the external device 210 via the input/output device 204.

The input/output device 204 allows the computing device 200 to communicate with the external device 210. For example, the input/output device 204 may include a transceiver, a network adapter, a network card, an interface, one or more communication ports (e.g., a USB port, serial port, parallel port, an analog port, a digital port, VGA, DVI, HDMI, Fire Wire, CAT 5, or any other type of communication port or interface), and/or other communication circuitry. Communication circuitry may be configured to use any one or more communication technologies (e.g., wireless or wired communications) and associated protocols (e.g., Ethernet, Bluetooth®, Wi-Fi®, WiMAX, etc.) to effect such communication depending on the particular computing device 200. The input/output device 204 may include hardware, software, and/or firmware suitable for performing the techniques described herein.

The external device 210 may be any type of device that allows data to be inputted or outputted from the computing device 200. For example, in various embodiments, the external device 210 may be embodied as one or more of the devices/systems described herein, and/or a portion thereof. Further, in some embodiments, the external device 210 may be embodied as another computing device, camera or other imaging device, printer, display, alarm, microphone, peripheral device (e.g., keyboard, mouse, touch screen display, etc.), and/or any other computing, processing, and/or communication device capable of performing the functions described herein. Furthermore, in some embodiments, it should be appreciated that the external device 210 may be integrated into the computing device 200.

The processing device 202 may be embodied as any type of processor(s) capable of performing the functions described herein. In particular, the processing device 202 may be embodied as one or more single or multi-core processors, microcontrollers, or other processor or processing/controlling circuits. For example, in some embodiments, the processing device 202 may include or be embodied as an arithmetic logic unit (ALU), central processing unit (CPU), digital signal processor (DSP), graphics processing unit (GPU), field-programmable gate array (FPGA), application-specific integrated circuit (ASIC), quantum computing processors, and/or another suitable processor(s). The processing device 202 may be a programmable type, a dedicated hardwired state machine, or a combination thereof. Processing devices 202 with multiple processing units may utilize distributed, pipelined, and/or parallel processing in various embodiments. Further, the processing device 202 may be dedicated to performance of just the operations described herein, or may be utilized in one or more additional applications. In the illustrative embodiment, the processing device 202 is of a programmable variety that executes algorithms and/or processes data in accordance with operating logic 208 as defined by programming instructions (such as software or firmware) stored in memory 206. Additionally or alternatively, the operating logic 208 for processing device 202 may be at least partially defined by hardwired logic or other hardware. Further, the processing device 202 may include one or more components of any type suitable to process the signals received from input/output device 204 or from other components or devices and to provide desired output signals. Such components may include digital circuitry, analog circuitry, or a combination thereof.

The memory 206 may be of one or more types of non-transitory computer-readable media, such as a solid-state memory, electromagnetic memory, optical memory, or a combination thereof. Furthermore, the memory 206 may be volatile and/or nonvolatile and, in some embodiments, some or all of the memory 206 may be of a portable variety, such as a disk, tape, memory stick, cartridge, and/or other suitable portable memory. In operation, the memory 206 may store various data and software used during operation of the computing device 200 such as operating systems, applications, programs, libraries, and drivers. It should be appreciated that the memory 206 may store data that is manipulated by the operating logic 208 of processing device 202, such as, for example, data representative of signals received from and/or sent to the input/output device 204 in addition to or in lieu of storing programming instructions defining operating logic 208. As shown in FIG. 2, the memory 206 may be included with the processing device 202 and/or coupled to the processing device 202 depending on the particular embodiment. For example, in some embodiments, the processing device 202, the memory 206, and/or other components of the computing device 200 may form a portion of a system-on-a-chip (SoC) and be incorporated on a single integrated circuit chip.

In some embodiments, various components of the computing device 200 (e.g., the processing device 202 and the memory 206) may be communicatively coupled via an input/output subsystem, which may be embodied as circuitry and/or components to facilitate input/output operations with the processing device 202, the memory 206, and other components of the computing device 200. For example, the input/output subsystem may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The computing device 200 may include other or additional components, such as those commonly found in a typical computing device (e.g., various input/output devices and/or other components), in other embodiments. It should be further appreciated that one or more of the components of the computing device 200 described herein may be distributed across multiple computing devices. In other words, the techniques described herein may be employed by a computing system that includes one or more computing devices. Additionally, although only a single processing device 202, I/O device 204, and memory 206 are illustratively shown in FIG. 2, it should be appreciated that a particular computing device 200 may include multiple processing devices 202, I/O devices 204, and/or memories 206 in other embodiments. Further, in some embodiments, more than one external device 210 may be in communication with the computing device 200.

The computing device 200 may be one of a plurality of devices connected by a network or connected to other systems/resources via a network (e.g., devices of the voting machine simulation system 110 or, more generally, the system 100). The network may be embodied as any one or more types of communication networks that are capable of facilitating communication between the various devices communicatively connected via the network. As such, the network may include one or more networks, routers, switches, access points, hubs, computers, client devices, endpoints, nodes, and/or other intervening network devices. For example, the network may be embodied as or otherwise include one or more cellular networks, telephone networks, local or wide area networks, publicly available global networks (e.g., the Internet), ad hoc networks, short-range communication links, or a combination thereof. In some embodiments, the network may include a circuit-switched voice or data network, a packet-switched voice or data network, and/or any other network able to carry voice and/or data. In particular, in some embodiments, the network may include Internet Protocol (IP)-based and/or asynchronous transfer mode (ATM)-based networks. In some embodiments, the network may handle voice traffic (e.g., via a Voice over IP (VOIP) network), web traffic, and/or other network traffic depending on the particular embodiment and/or devices of the system in communication with one another. In various embodiments, the network may include analog or digital wired and wireless networks (e.g., IEEE 802.11 networks, Public Switched Telephone Network (PSTN), Integrated Services Digital Network (ISDN), and Digital Subscriber Line (xDSL)), Third Generation (3G) mobile telecommunications networks, Fourth Generation (4G) mobile telecommunications networks, Fifth Generation (5G) mobile telecommunications networks, a wired Ethernet network, a private network (e.g., such as an intranet), radio, television, cable, satellite, and/or any other delivery or tunneling mechanism for carrying data, or any appropriate combination of such networks. It should be appreciated that the various devices/systems may communicate with one another via different networks depending on the source and/or destination devices/systems.

It should be appreciated that the computing device 200 may communicate with other computing devices 200 via any type of gateway or tunneling protocol such as secure socket layer or transport layer security. The network interface may include a built-in network adapter, such as a network interface card, suitable for interfacing the computing device to any type of network capable of performing the operations described herein. Further, the network environment may be a virtual network environment where the various network components are virtualized. For example, the various machines may be virtual machines implemented as a software-based computer running on a physical machine. The virtual machines may share the same operating system, or, in other embodiments, different operating system may be run on each virtual machine instance. For example, a “hypervisor” type of virtualizing is used where multiple virtual machines run on the same host physical machine, each acting as if it has its own dedicated box. Other types of virtualization may be employed in other embodiments, such as, for example, the network (e.g., via software defined networking) or functions (e.g., via network functions virtualization).

Accordingly, one or more of the computing devices 200 described herein may be embodied as, or form a portion of, one or more cloud-based systems. In cloud-based embodiments, the cloud-based system may be embodied as a server-ambiguous computing solution, for example, that executes a plurality of instructions on-demand, contains logic to execute instructions only when prompted by a particular activity/trigger, and does not consume computing resources when not in use. That is, system may be embodied as a virtual computing environment residing “on” a computing system (e.g., a distributed network of devices) in which various virtual functions (e.g., Lambda functions, Azure functions, Google cloud functions, and/or other suitable virtual functions) may be executed corresponding with the functions of the system described herein. For example, when an event occurs (e.g., data is transferred to the system for handling), the virtual computing environment may be communicated with (e.g., via a request to an API of the virtual computing environment), whereby the API may route the request to the correct virtual function (e.g., a particular server-ambiguous computing resource) based on a set of rules. As such, when a request for the transmission of data is made by a user (e.g., via an appropriate user interface to the system), the appropriate virtual function(s) may be executed to perform the actions before eliminating the instance of the virtual function(s).

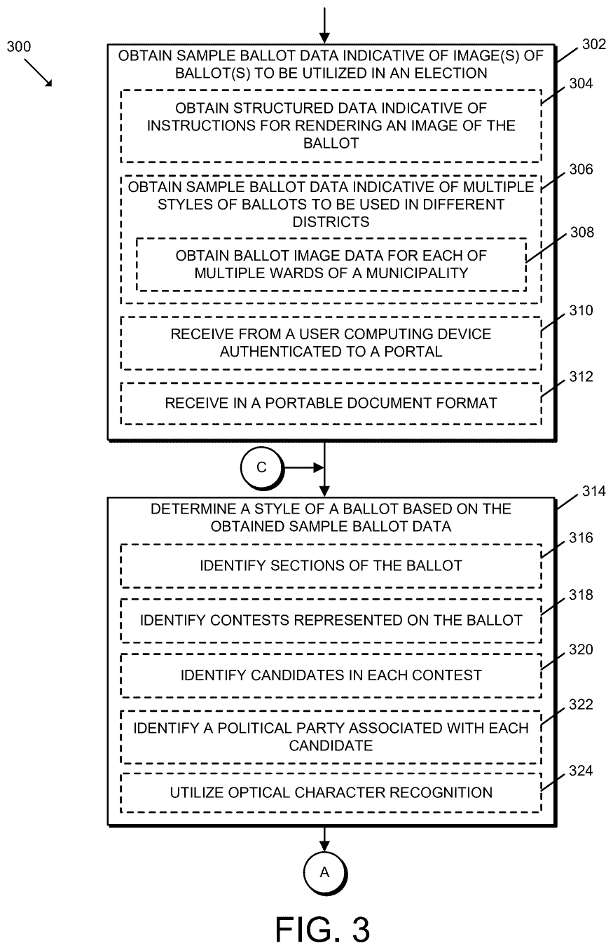

Referring now to FIG. 3, in use, a computing system (e.g., the system 100, including the voting machine simulation system 110, and/or other computing devices described herein) may execute a method 300 for producing a simulated poll tape to enable efficient verification of the operation of a voting machine. In the illustrative embodiment, it should be appreciated that the method 300 may be executed, in full or in part, by the voting machine simulation system 110 of the system 100. It should be appreciated that the particular blocks of the method 300 are illustrated by way of example, and such blocks may be combined or divided, added or removed, and/or reordered in whole or in part depending on the particular embodiment, unless stated to the contrary.

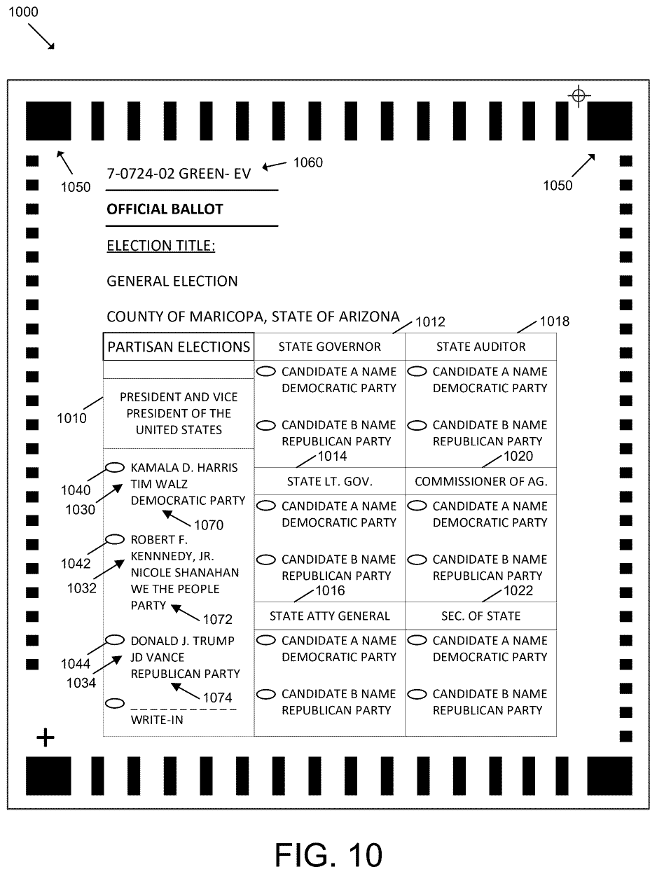

The illustrative method 300 begins with block 302 in which the computing system obtains sample ballot data, which may be embodied as any data that is indicative of one or more images of one or more ballots to be utilized in an election. In some embodiments, the sample ballot data may be embodied as a machine readable description of the style(s) of one or more ballots. A diagram of an example ballot 1000 that may be represented in the sample ballot data is shown in FIG. 10. In block 304, the computing system may obtain structured data indicative of instructions for rendering an image of a corresponding ballot. For example, the sample ballot data may be encoded as a set of instructions, in a markup language, indicating fonts, text, lines, or other shapes or visual elements to be rendered to produce an image of the corresponding ballot. As indicated in block 306, the computing system may obtain sample ballot data that is indicative of multiple styles of ballots to be used in different districts (e.g., the districts 160, 162). The computing system may obtain ballot image data for each of multiple wards of a municipality, in block 308. In the illustrative embodiment, the computing system obtains the sample ballot data from a user computing device (e.g., a user device 140, 142) that is authenticated to a portal, such as a web interface provided by the computing system (e.g., the voting machine simulation system 110), in block 310. In some embodiments, the computing system may receive the sample ballot data in a portable document format (e.g., as one or more PDF files), as indicated in block 312.

The method 300, in the illustrative embodiment, advances to block 314, in which the computing system determines a style of a ballot based on the obtained sample ballot data. In doing so, the computing system identifies different sections of the ballot, as indicated in block 316. For example, and as indicated in block 318, the computing system identifies contests represented in the ballot. Referring to the ballot shown in FIG. 10, the computing system may identify, for example, a contest 1010 for president and vice president of the United States, a contest 1012 for a state governor, a contest 1014 for a state lieutenant governor, a contest 1016 for a state attorney general, a contest 1018 for a state auditor, a contest 1020 for a state commissioner for agriculture, and a contest 1022 for a secretary of state, among others that may be represented on the ballot. Further, the computing system identifies candidates in each contest, as indicated in block 320. For example, for the contest 1010, the computing system may identify the candidates 1030, 1032, 1034. Additionally, in block 322, the computing system additionally identifies a political party associated with each of the candidates determined in block 320. For example, the computing system may identify the political parties 1070, 1072, 1074 appearing after the names of the candidates 1030, 1032, 1034 in the contest 1010 on the ballot 1000. In determining the above information concerning the style of the ballot, including the contests, candidates, and political parties, the computing system may utilize optical character recognition to determine the letters, numbers or other characters represented in the image of the ballot (e.g., if a corresponding textual version of the information is not available in the sample ballot data), as indicated in block 324.

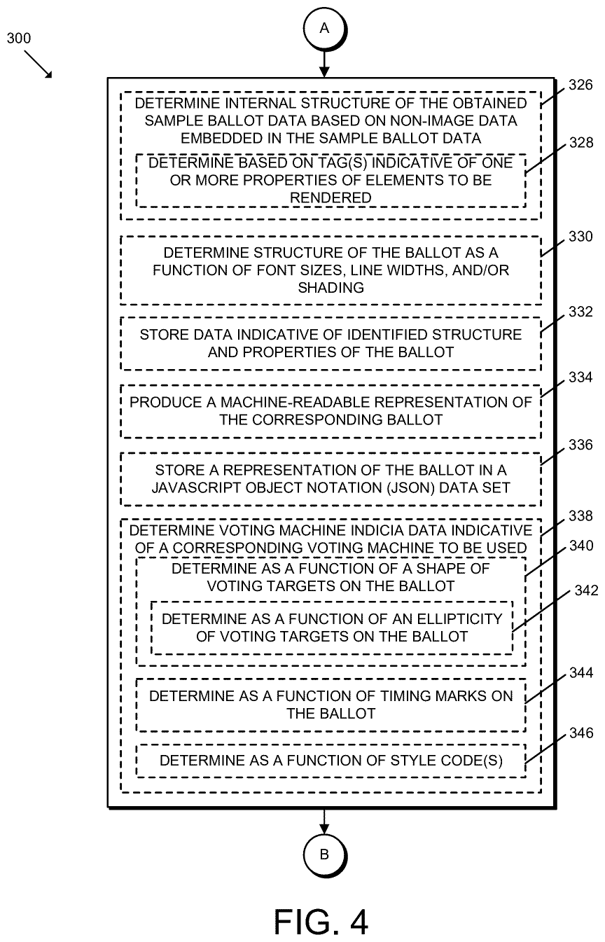

Continuing the method, and referring now to FIG. 4, in determining the style of the ballot, the computing system may determine the internal structure of the obtained sample ballot data based on non-image data embedded in the sample ballot data, as indicated in block 326. In doing so, the computing system may determine the internal structure based on one or more tags that are indicative of properties of elements to be rendered, as indicated in block 328. In block 330, the computing system may determine a structure of the ballot as a function of font sizes, line widths, and/or shading. For example, larger font sizes may be indicative of a heading of a section, such as the name of a contest to be voted on. Within that section, names of candidates may be associated with a smaller font. The computing system may determine that relatively thicker lines demarcate sections (e.g., contests) from each other. Similarly, the computing system may determine that areas having a particular shading that differs from other shading on the ballot may represent corresponding sections of the ballot. In the illustrative embodiment, the computing system, in block 332, stores data indicative of the identified structure and properties of the ballot (e.g., in the memory 206). As indicated in block 334, the computing system may produce a machine-readable representation of the corresponding ballot, such that the ballot is encoded in a format that can be more efficiency parsed by the computing system than image data (e.g., pixel values). For example, and as indicated in block 336, the computing system may store a representation of the ballot in a JavaScript Object Notation (JSON) data set (e.g., a file, a blob in a database, etc.).

The computing system, in the illustrative embodiment, further determines voting machine indicia data that is indicative of a corresponding voting machine (e.g., a voting machine 150, 152) to be used in connection with the ballot represented in the sample ballot data, as indicated in block 338. In doing so, the computing system may determine the voting machine indicia data as a function of a shape of voting targets 1040, 1042, 1044 on the ballot (e.g., the ballot 1000), as indicated in block 340. For example, the computing system may determine an ellipticity of the voting targets 1040, 1042, 1044 on the ballot (e.g., the ballot 1000) in block 342, if the voting targets are elliptical. In doing so, the computing system may determine a ratio of a major axis to a minor axis for each voting target. Accordingly, if the ratio is one to one, the voting targets, are circular. Otherwise, the voting targets are ovals. The computing system may also determine the voting machine indicia data as a function of timing marks on the ballot, as indicated in block 344. For example, the computing system may analyze the timing marks 1050 represented on the ballot 1000. The timing marks, if present, indicate to the corresponding voting machine 150, 152 where the voting targets are on the ballot (e.g., the voting targets 1040, 1042, 1044, among others, on the ballot 1000). Depending on the style of the ballot, which is determined at least in part by the type of voting machine 150, 152 that will be used to analyze the votes represented on the ballot, the timing marks and corresponding positions may vary. Similarly, the computing system may detect a style code that may be represented on the ballot, as indicated in block 346. For example, the computing system may detect the style code 1060 on the ballot 1000. The style code may embodied as an sequence of letters, numbers, and/or other symbols, that together represent a unique code indicative of the style of the ballot and may be further indicative of the voting machine with which the ballot is to be used.

In some embodiments, the computing system may utilize a large vision model (LVM) to identify features of a sample ballot to enable identification of the corresponding voting machine. A large vision model may be embodied as a set of neural networks focused solely on processing visual data to perform object classification, object detection, image segmentation, and/or image generation. A large vision model may be trained to perform object recognition and feature extraction with less labeled data than other computer vision models and may output bounding boxes, localize specific objects within an image, and discern information regarding spatial relationships (e.g., distances between objects) within an image.

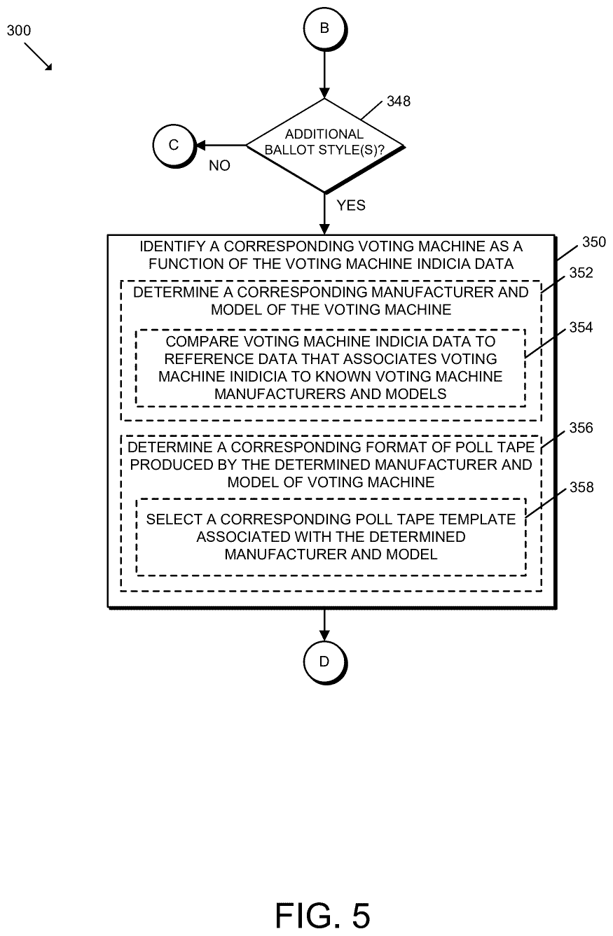

In the illustrative embodiment, the method 300 advances to block 348 of FIG. 5, in which the computing system, after determining the style of a given ballot in the sample ballot data, determines whether other ballots representative of other styles have yet to be analyzed in the sample ballot data. If so, the method 300 loops back to block 314 of FIG. 3, in which the computing system determines a style of another ballot represented in the obtained sample ballot data. Otherwise, if all styles of ballots represented in the sample ballot data have been determined, the method 300 advances to block 350, in which the computing system identifies a corresponding voting machine as a function of the voting machine indicia data. In the illustrative embodiment, the computing system determines a corresponding voting machine for each set of voting machine indicia data (e.g., for each style of ballot determined in block 314). In at least some embodiments, the computing system determines a corresponding manufacturer and model of the voting machine based on the voting machine indicia data for a given style of ballot, as indicated in block 352. In doing so, in block 354, the computing system may compare the voting machine indicia data to a set of reference data, such as the machine indicia data 130, that associates voting machine indicia to known voting machine manufacturers and models.

The computing system may perform a similarity comparison to identify the most similar indicia in the machine indicia data 130 to the voting machine indicia data determined in block 338. In at least some embodiments, the computing system may produce a vector with numerical values representing each of the features determined in block 338 and may perform a similarity comparison with corresponding vectors indicative of machine indicia for each of multiple known manufacturers and models of voting machines represented in the machine indicia data 130. In such embodiments, the similarity comparison may be the result of a dot product operation, which provides a scalar value indicative of similarity between the two vectors, with a larger number representing greater similarity. In other embodiments, the computing system may perform other measures of similarity, such as Euclidean distance or cosine similarity determinations.

Further, the computing system determines a corresponding format of poll tape produced by the determined manufacturer and model of voting machine, in block 356. In doing so, the computing system may select a corresponding poll tape template associated with the determined manufacturer and model, as indicated in block 358. The templates may be stored in or referenced by the machine indicia data 130, in association with the corresponding identifier of the manufacturer and model of the voting machine. The templates, in at least some embodiments, may be embodied as combinations of hypertext markup language (HTML) and cascading style sheets (CSS). In some embodiments, the computing system may access and manipulate the templates with a web template engine, such as Jinja, for the Python programming language.

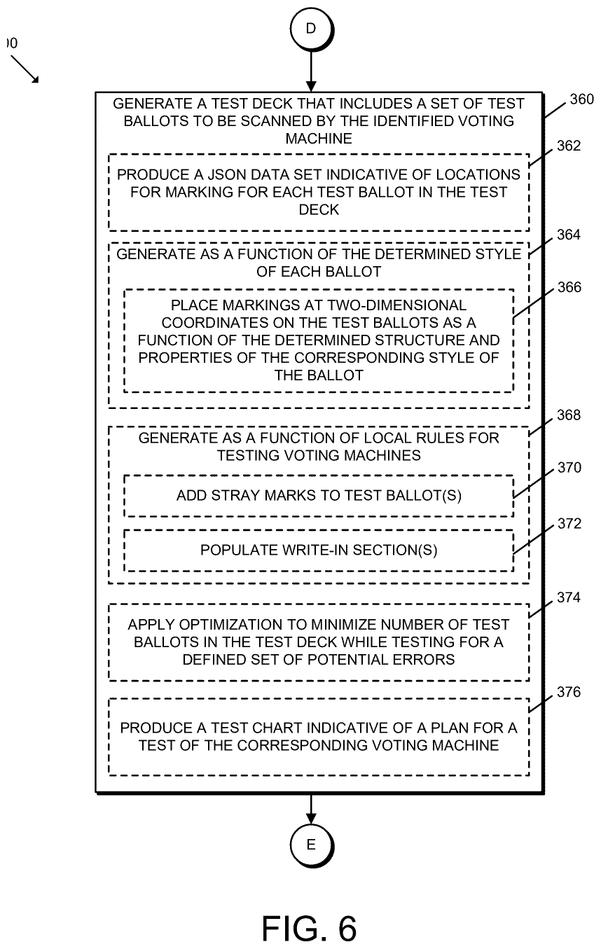

Referring now to FIG. 6, the method continues in block 360, in which the computing system generates a test deck. The test deck, in the illustrative embodiment, includes a set of test ballots to be scanned by the identified voting machine 150, 152. In generating the test deck, the computing system may produce a JSON (JavaScript Object Notation) data set that is indicative of locations for markings for each test ballot in the test deck, as indicated in block 362. In other embodiments, the computing system may generate a data set in a different format, such as extensible markup language (XML) or another human readable markup language, or a non-human readable data structure. The computing system, in the illustrative embodiment, generates a test deck as a function of (e.g., based on) the determined style of each corresponding ballot that was represented in the sample ballot data, as indicated in block 364. That is, the computing system generates a test deck for each style of ballot represented in the sample ballot data. In doing so, in block 366, the computing system places markings at two-dimensional coordinates (e.g., x and y coordinates) on each of the test ballots as a function of the determined structure and properties of the corresponding style of the ballot.

As described above, different ballot styles may have different locations for the voting targets and the shapes of the voting targets may differ as well (e.g., circular vs. oval). The markings represent votes that will be scanned by the corresponding voting machine 150, 152 to determine the numbers of votes for each candidate for each contest represented on the corresponding test ballot. In at least some embodiments, the computing system generates the test deck as a function of (e.g., based on) local rules, such as at the state or district level, for testing voting machines. Those rules may be represented in the voting rules data 132 described above or another data source that is accessible to the computing system. In generating the test deck based on local rules, in block 370, the computing system may add a required number of stray marks to one or more test ballots in the test deck. The stray marks may be embodied as marks that fall outside of the voting targets on the test ballot. Additionally or alternatively, in block 372, the computing system may populate one or more write-in sections on a test ballot. For example, the computing system may enter text or simulated handwriting into one or more areas on a test ballot in which a name of a candidate who is not in the list of candidates for the corresponding contest may be written.

In some embodiments, in block 374, the computing system may apply an optimization to minimize the number of test ballots in the test deck while enabling testing for a defined set of potential errors in the operation of the corresponding voting machine. Those errors may include, for example, transposition errors, in which votes represented on the test ballots in the test deck for one candidate are attributed, by the voting machine 150, 152, to a different candidate associated with the contest. That is, due to intentional or unintentional misconfiguration of the voting machine 150, 152, the positions of two candidates are switched in the memory of the voting machine 150, 152 such that, when the voting machine 150, 152 detects a marking at a first position (e.g., in a first voting target), the voting machine 150, 152 increases the number of counted votes for a candidate associated with, for example, a second position rather than the first position. Techniques for optimizing the test deck to reduce the number of test ballots while retaining the ability to test for such errors are described in U.S. patent application Ser. No. 18/394,391, the contents of which are incorporated herein by reference in their entirety.

An overview of such techniques follows, in which a test deck of ballots having an optimized number a ballots (a “minimum test deck”) may be produced. An election may include a set of contests, as shown in the following equation:

$$\text{?} \hat{=} \{ 1 , … , C \} . \qquad ( Equation 1 )$$

Further, the election may include a set of candidates, as set forth in the relationship below:

$$\text{?} \hat{=} \{ 1 , … , N \} . \qquad ( Equation 2 )$$

Continuing the scenario above, each contest within the set of contests may be expressed as follows:

$$c ∈ \text{?} . \qquad ( Equation 3 )$$

Further, a subset of candidates appearing in connection with the contest c may be represented as shown below:

$${\text{?}}_{C} ⊆ N . \qquad ( Equation 4 )$$

In the above scenario, the maximum number of candidates that a voter may select, according to the applicable laws or regulations, is represented as vₑ for purposes of the description. Accordingly, for a contest, c, specifically for a senatorial election, within the entire set of contests, [symbol] , the set of candidates that may be selected from for that specific senatorial contest is [symbol] _{c}. Further, the relationship shown below would be present, indicating that each voter may select up to one candidate in the contest for election of a senator:

$${v}_{c} = 1 . \qquad ( Equation 5 )$$

Other contests may allow a voter to select more than one candidate, such as in a contest for a school board. Further, in at least some embodiments, the computing system may be configured based on the rule that each candidate may only appear in a single contest, according to the following relationship:

$$i ∈ \text{?} . \qquad ( Equation 6 )$$

Continuing the description of the relationships, a ballot represents a subset of candidates, as follows:

$$β ⊆ \text{?} . \qquad ( Equation 7 )$$

In the above, the following relationship is true only if the ballot contains a vote for candidate i:

$$i ∈ β . \qquad ( Equation 8 )$$

Further, in the description provided herein, a deck represents a sequence of ballots having a finite size, B.

$$deck = ( {β}_{1} , … , {β}_{B} ) . \qquad ( Equation 9 )$$

A ballot may be determined to represent an overvote for a contest, c, within the total set of contests, [symbol] if more than the maximum permissible number of votes were cast for candidates in that contest, as follows:

$$\vert β ⋂ {\text{?}}_{C} \vert > {v}_{c} . \qquad ( Equation 10 )$$

In the scenario where an overvote condition is determined to exist, the ballot may be treated as if no selections for any candidates were made for that contest on the ballot. Further, the set of ballots that do not represent an overvote condition for any contest, c, within the total set of contests, [symbol] may be represented as follows:

$$ℬ \hat{=} \{ β ⊆ \text{?} : \vert {\text{?}}_{C} ⋂ β \vert \leq v for all c ∈ \text{?} \} . \qquad ( Equation 11 )$$

As described herein, a voting machine, when operating correctly, will output the number of votes indicated on the ballots for each candidate, excluding any overvote conditions. The output of the voting machine may be represented as the following vector, for a given input deck of ballots:

$${T}^{*} ( {β}_{1} , … , {β}_{B} ) ≡ ( {T}_{1}^{*} ( {β}_{1} , … , {β}_{B} ) , … , {T}_{N}^{*} ( {β}_{1} , … , {β}_{B} ) ) . \qquad ( Equation 12 )$$

Further, the following relationship applies:

$${T}_{i}^{*} ( {β}_{1} , … , {β}_{B} ) \hat{=} {\sum }_{b ∈ \{ 1 , … , B \}} I \{ i ∈ {β}_{b} and \vert {N}_{C} ⋂ β \vert \leq {v}_{C} \} . \qquad ( Equation 13 )$$

While the above equation represents the proper operation of a voting machine in totaling or tallying votes for candidates, the function of a voting machine that is not operating correctly (e.g., is misconfigured), may be represented by the following equation:

$$\check{T} ( {β}_{1} , … , {β}_{B} ) ≡ ( {\check{T}}_{1} ( {β}_{1} , … , {β}_{B} ) … , {\check{T}}_{N} ( {β}_{1} , … {β}_{B} ) ) . \qquad ( Equation 14 )$$

If the results of Equations 13 and 14 are not equal, then the output of the voting machine does not accurately reflect the votes cast on the ballots in the deck of ballots that were provided to the voting machine.

For testing the logic and accuracy of a voting machine, some districts or jurisdictions may apply special requirements beyond the standard requirement that each candidate in a contest should receive at least one vote. For example, some jurisdictions require that each candidate in a contest receive a different number of votes. Further, some jurisdictions require that the deck contain at least one overvoted ballot or a completely blank ballot. The total set of ballots in a deck that satisfies the applicable requirements for logic and accuracy testing in a jurisdiction is expressed herein as [symbol] , as follows:

$$\text{?} = ( {β}_{1} , … , {β}_{B} ) . \qquad ( Equation 15 )$$

During logic and accuracy testing, to verify that a voting machine has not been misconfigured, an uncertainty set may be defined, representing the possible ways (referred to herein as misconfigurations) through which the voting machine may operate incorrectly. Provided a given uncertainty set, the computing system may solve an optimization problem, referred to herein as a robust optimization (RO) to determine a test deck that will reveal whether a voting machine is misconfigured in any of the ways represented in the uncertainty set. The uncertainty set is represented herein as [symbol] . In the uncertainty set, [symbol] , each possible misconfiguration is represented as a vector-valued function as follows:

$$T ( \cdot ) ≡ ( {T}_{1} ( \cdot ) , … , {T}_{N} ( \cdot ) ) . \qquad ( Equation 16 )$$

The computing system may solve the robust optimization to determine a minimum test deck, that includes only the minimum number of test ballots needed to test the voting machine for a possible misconfiguration represented in the uncertainty set as follows:

$$Minimize B , B ∈ N , ( β 1 , … , β B ) ∈ D . \qquad ( Equation 17 )$$

The above equation, representing the robust optimization, is subject to the following constraints:

$$T ( {β}_{1} , … , {β}_{B} ) \neq {T}^{*} ( {β}_{1} , … , {β}_{B} ) ∀ T ( \cdot ) ∈ \text{?} . \qquad ( Equation 18 )$$

In the robust optimization, the decision variables include the length of the test deck, as follows:

$$B ∈ ℕ . \qquad ( Equation 19 )$$

In the above equation, [symbol] represents a set of positive whole numbers. Further, the ballots in a test deck having length B must satisfy the requirements for logic and accuracy testing according to the corresponding jurisdiction, as follows:

$$( {β}_{1} , … , {β}_{B} ) ∈ \text{?} . \qquad ( Equation 20 )$$

The above constraints cause the resulting test deck to be feasible only if the output of the voting machine on the test deck Ť (β₁, . . . , β_{B}) is different from the output of the operation of the voting machine on the test deck T*(β₁, . . . , β_{B}) only when the voting machine is subject to one of the misconfigurations represented in the uncertainty set, [symbol] . In other words, the constraints on the robust optimization cause the results (e.g., totals or tallies) of the voting machine to differ from the correct results only if the voting machine is misconfigured according to a misconfiguration represented in the uncertainty set, [symbol] .

In some embodiments, the computing system may perform the robust optimization to produce the minimum test deck in two sections, with a first section performing the robust optimization subject to the following:

$$T ( {β}_{1} , … , {β}_{B} ) \neq {T}^{*} ( {β}_{1} , … , {β}_{B} ) . \qquad ( Equation 20 )$$

Further, a second part of the operation of the computing system may determine a corresponding misconfiguration that defeats the minimized test deck. The second section may determine the misconfiguration without consideration the entire uncertainty set, as represented below:

$$∀ T ( \cdot ) ∈ \text{?} . \qquad ( Equation 21 )$$

The uncertainty set, [symbol] , may be easily updated to reflect additional or different potential misconfigurations as those possible misconfigurations develop over time (e.g., are discovered). The uncertainty set may include misconfigurations relating to transposition. The uncertainty set in some embodiments, may include all potential malfunctions in which the votes of candidates within and across any number of contests associated with an election are swapped. For example, the transposition uncertainty set may include all possible flawed bijections from voting targets on a ballot to candidates.

A transposition uncertainty set may represent simple misconfigurations of a voting machine that may occur by accident or through intentional effort, such as in an attempt to disrupt the results of an election. Non-identity bijections having the form shown below may constitute a set Σ.

$$σ : \text{?} \to \text{?} . \qquad ( Equation 22 )$$

In the above, the function σ(·) represents non-identity bijections if two conditions are true. First, for every candidate, j, in the election, a voting target, i, must exist that satisfies the relationship below:

$$σ ( i ) = j . \qquad ( Equation 23 )$$

Second, a voting target, i, must exist that satisfies the following relationship:

$$σ ( i ) \neq i . \qquad ( Equation 24 )$$

Each function σ: [symbol] → [symbol] represents a mapping from two-dimensional locations on a ballot to corresponding candidates who receive votes when those locations (e.g., voting targets) are marked (e.g., filled in). Accordingly, a set of all possible swaps is represented below:

$$\text{?} \hat{=} \{ {T}^{σ} ( \cdot ) ≡ ( {T}_{1}^{σ} ( \cdot ) , … , {T}_{N}^{σ} ( \cdot ) ) : σ ∈ \sum \} . \qquad ( Equation 24 )$$

In the above, the following relationship is present for each candidate, i, in the set of candidates [symbol] _{c}, for each corresponding contest c, in the set of contests [symbol] in the election:

$${T}_{i}^{σ} ( {β}_{1} , … , {β}_{B} ) \hat{=} {\sum }_{b = 1}^{B} I \{ there exists j ∈ {β}_{b} such that σ ( j ) = i and \vert \{ j ∈ {β}_{b} : σ ( j ) ∈ {N}_{C} \} \vert \leq {v}_{C} \} . \qquad ( Equation 25 )$$

According to the above, the operation of a properly functioning voting machine can be reframed as the tally equation above, parameterized by the identity function shown below:

$${*}^{} : \text{?} \to \text{?} . \qquad ( Equation 26 )$$

In the above equation, for all locations (e.g., voting targets), i, in the set [symbol] , the following relationship is present:

$${*}^{} ( i ) = i . \qquad ( Equation 27 )$$

Accordingly, by performing the robust optimization, the computing system determines the minimum-length test deck such that for every non-identity bijection, σ, in the set, Σ, the following relationship exists:

$${T}^{*} ( {β}_{1} , … , {β}_{B} ) \neq {T}^{σ} ( {β}_{1} , … , {β}_{B} ) \qquad ( Equation 28 )$$

By producing a minimum test deck that reduces the number of test ballots while still enabling verification of the operation of the voting machine with one or more ballots that reveal a potential misconfiguration, the computing system may reduce the amount of time and complexity involved in conducting a logic and accuracy test.

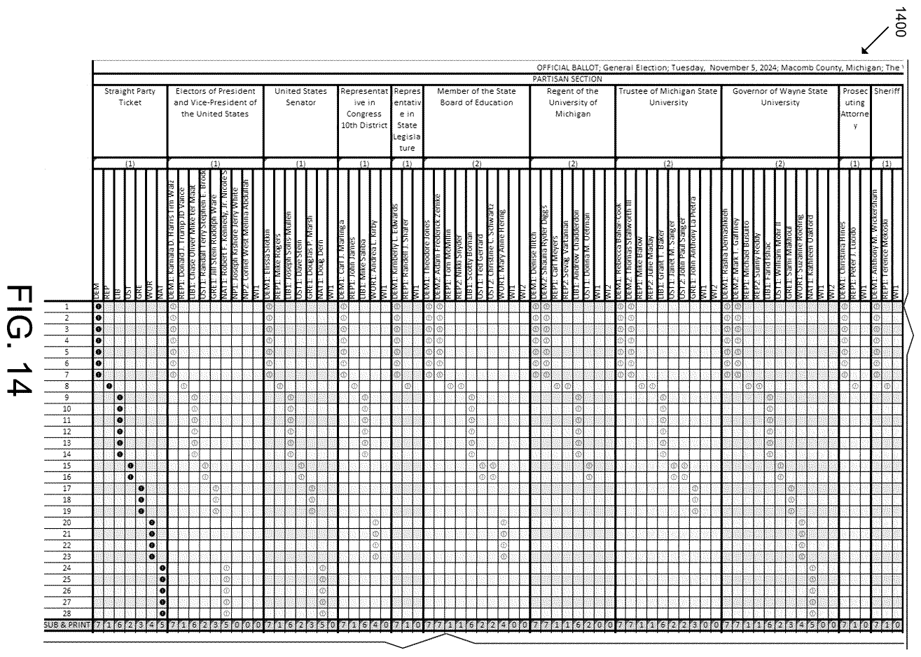

In at least some embodiments, the computing system may additionally produce a test chart that is indicative of a plan for a test of the corresponding voting machine 150, 152, as indicated in block 376. That is, the computing system may generate a table or spreadsheet that indicates the votes represented on each test ballot in the test deck, and the total number of votes associated with each candidate for each contest. A partial view of a test chart 1400 that may be produced by the computing system is shown in FIG. 14.

In some embodiments, the computing system may generate multiple test decks for each style of ballot, such that a given test has multiple parts. For example, a test may include a first part in which all votes are straight party votes, in which rather than selecting individual candidates, a selection of a vote for a political party is mapped to corresponding candidates for each of the contests represented on the ballot. Another part of the test, and another test deck for that same style of ballot, may include a varied set of votes that are not exclusively straight party votes. Further, a third part of the test, and a corresponding third test deck for that style of ballot may include stray marks, write-ins, missing votes for certain contests (e.g., undervote conditions), and/or more than an allowed number of votes for one or more contests (e.g., overvote conditions).

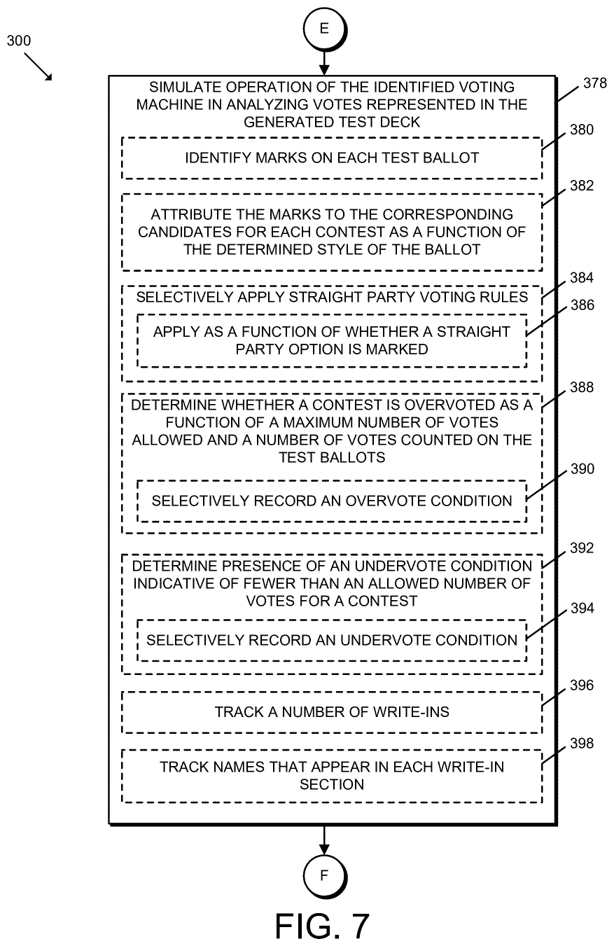

Continuing the method 300, in block 378 of FIG. 7, the computing system may simulate operation of the identified voting machine 150, 152 in analyzing votes represented test deck(s) generated in block 360 for that voting machine 150, 152. In doing so, the computing system identifies marks on each test ballot in the test deck, as indicated in block 380. In doing so, in at least some embodiments, the computing system may not scan a physical version of each test ballot but instead may parse the data set produced in block 362, which indicates the locations for the markings on each test ballot associated with a given test deck. In block 382, the computing system attributes the marks to the corresponding candidates for each contest as a function of the determined style of the ballot. That is, the computing system compares the markings at identified coordinates on a given test ballot in a test deck and determines the corresponding candidates to which the markings pertain based on the identified structure and properties of the corresponding ballot style, which indicates the sections of the ballot, the contests in the ballot, the candidates for each contest, the positions and shapes of the voting targets, and related features, as described above. In block 384, the computing system may selectively apply straight party voting rules. In doing so, the computing system may apply the straight party voting rules as a function of whether a straight party option is marked on the corresponding test ballot, as indicated in block 386. The rules may define which candidate or candidates is to receive corresponding vote(s) in each competition based on which party was selected in a straight party voting section of the test ballot.

Additionally or alternatively, the computing system may determine whether a contest is overvoted as a function of a maximum number of votes allowed and a number of votes counted on the test ballots in the test deck, in block 388. For example, if a given contest allows a voter to select two candidates and the total number of test ballots is 40, the resulting maximum number of votes allowed for the contest is 80. If the computing system determines that more than 80 votes are present, or that any given test ballot has more than two votes indicated for that contest, the computing system may record an indication that an overvote condition is present, in block 390. Relatedly, the computing system may determine the presence of an undervote condition, indicative of fewer than an allowed number of votes for a contest, in block 392. Using the example provided above, if the number of votes represented in the test deck is less than 80 for that contest or if a given test ballot in the test deck represents fewer than two votes for the contest, the computing system may record an indication that an undervote condition is present, in block 394. Aside from overvote and undervote conditions, the computing system may track other information represented in the test ballots of a test deck, such as the number of write-ins represented in the test deck, as indicated in block 396, and the content (e.g., the names) that appear in the write-in sections on the test ballots in the test deck, in block 398. The amount and types of information collected by the computing system for each test deck may be a super set of the information that is to be presented on a corresponding poll tape produced by the voting machine 150, 152 that is being simulated.

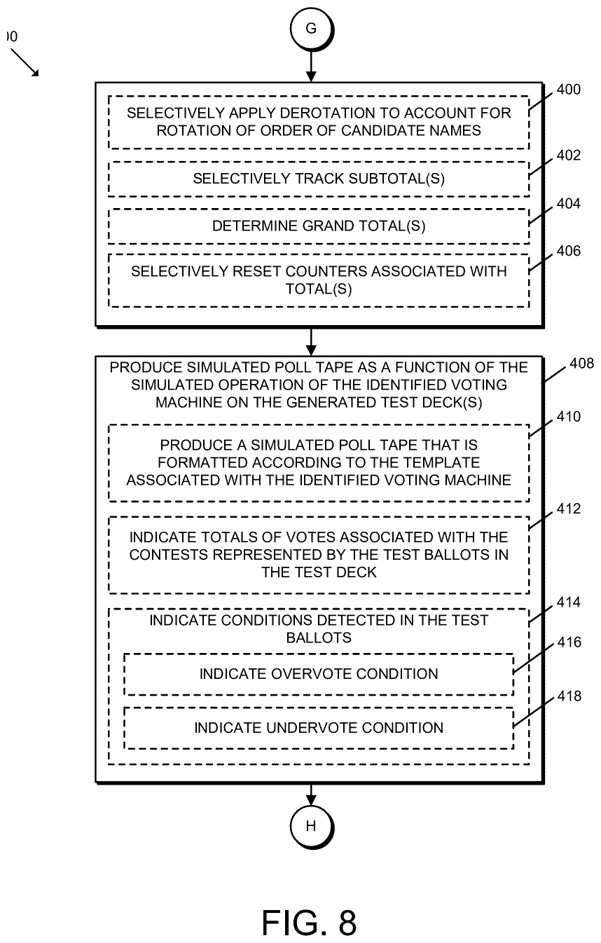

Continuing the method 300 in block 400 of FIG. 8, the computing system may selectively apply de-rotation to account for rotations (e.g., modifications) in the order of candidate names. That is, according to applicable voting rules, which may be represented in the voting rules data 132, the ordering of candidate names may vary across districts 160, 162 (e.g., ward) to the negate or balance any potential advantage that a candidate may otherwise receive by having his or her name appear first in a set of candidates for a given contest. The exact scheme for rotating the ordering of candidate names may vary across districts. Given a sample ballot, the computing system may de-rotate the order of candidates to find the home rotation, and use the home rotation to determine the order of candidates shown on the poll tape. Doing so ensures that the simulated poll tape is a good visual match for the output of the actual voting machine 150, 152.

In block 402, the computing system may track subtotals associated with corresponding portions of a validation process based on the test deck(s) associated with a given ballot style and voting machine 150, 152. For example, continuing the example above, the computing system may track sub totals for each of three test decks. Each of the three test decks may represents a corresponding type of voting scenario, such as a test deck of straight party votes, a test deck of candidate-specific votes, and a test deck representing one or more of write-ins, overvote conditions, and/or undervote conditions. The computing system, in block 404, may also determine grand total(s), such as a grand total of votes for each candidate across all test decks for a given ballot style and voting machine 150, 152. Relatedly, and as indicated in block 406, the computing system may selectively reset one or more counters, such as between determinations of subtotals and/or a grand total.

The method 300 continues in block 408, in which the computing system produces a simulated poll tape as a function of (e.g., based on) the simulated operation of the corresponding voting machine 150, 152 on the generated test deck(s). In some embodiments, the computing system may produce the simulated poll tape based on votes represented in a corresponding test chart, such as the test chart produced in block 376 or a test chart from another source. In doing so, and as indicated in block 410, the computing system produces a simulated poll tape that is formatted according to the template associated with the identified voting machine 150, 152. That is, the computing system produces a poll tape that corresponds with the format utilized by the voting machine 150, 152 identified by the operations of block 350. In producing the simulated poll tape, in block 412, the computing system indicates totals of votes associated with the contests represented by the test ballots in each test deck analyzed in connection with the simulated operation of the corresponding voting machine 150, 152. Further, the computing system indicates any conditions that were detected in the test ballots, in block 414. In doing so, the computing system may indicate, on the simulated poll tape, the presence of an overvote condition in connection with a particular contest, in block 416. Additionally or alternatively, the computing system may indicate, on the simulated poll tape, the presence of an undervote condition in connection with a corresponding contest, in block 418. In doing so, the computing system produces the indication in the format that would be utilized by the corresponding voting machine 150, 152.

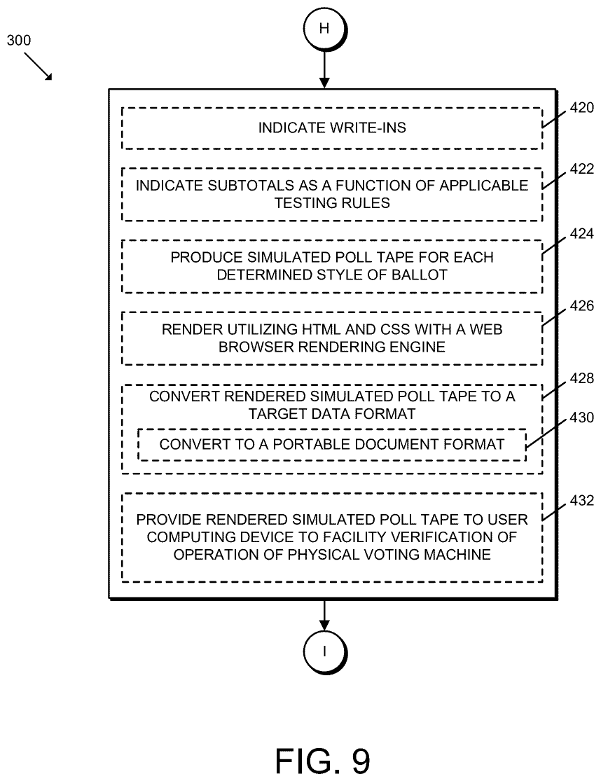

The method 300, in the illustrative embodiment, continues in block 420 of FIG. 9, in which the computing system may indicate write-ins on the simulated poll tape. In some embodiments, the computing system may not indicate undervote conditions, overvote conditions, and/or write-ins if the applicable testing rules for the district 160, 162 indicate that such information is not to be represented on a poll tape. In block 422, the computing system, in the illustrative embodiment, may indicate one or more subtotals, such as a set of subtotals for each test deck in a multi-part test of a voting machine, as a function of (e.g., based on) applicable testing rules. That is, the computing system may selectively include the sub totals based on whether the applicable testing rules for the district require subtotals to be indicated on a poll tape. In the illustrative embodiment, the computing system produces a simulated poll tape for each determined style of ballot, based on the corresponding analysis of the votes represented in the test decks associated with that style of ballot, as indicated in block 424.

The computing system may render each simulated poll tape utilizing a combination of HTML and CSS and a corresponding web browser rendering engine, in block 426. That is, as described above, the computing system may utilize a template that includes a combination of HTML and CSS, such as with Jinja, to represent the simulated poll tape in the format utilized by the corresponding voting machine 150, 152, and provide the resulting poll tape encoded in HTML and CSS to a web browser engine, such as WebKit or Gecko. In other embodiments, the web browser engine may be executed by a user computing device, which receives the HTML and CSS (e.g., via the network 170, in response to a corresponding request) representing the simulated poll tape, such that the resulting visual representation is displayed to the user of the user computing device. In some embodiments, the computing system may convert the rendered simulated poll tape to a target data format, as indicated in block 428. For example, the computing system may convert the rendered simulated poll tape to a portable document format (e.g., a PDF file), as indicated in block 430.

In some embodiments, rather than utilizing a predefined template that includes a set of HTML and CSS, the computing system may utilize artificial intelligence to produce the simulated poll tape. For example, the computing system may utilize a neural network, such as a recurrent neural network (RNN), that operates on a continuous representation or embedding of tokens as a non-linear combination of weights. A neural network, also referred to herein as an artificial neural network, is a set of connected units or nodes that model the neurons in a brain and that are connected via edges, which model synapses in the brain. Each neuron is configured to receive corresponding signals from connected neurons, then process those signals and produce a resulting signal to other connected neurons. The resulting signal is produced based on an activation function, which is a function that determines an output of a node based on the individual inputs and weights associated with those inputs. The activation function may be, for example, a rectified linear unit activation function, a gaussian error linear unit activation function, or a logistic sigmoid function. An RNN is a specialized type of artificial neural network that utilizes a recurrent unit that maintains a hidden state that is updated for each of multiple time steps based on a present input and a previous hidden state. A feedback loop may enable the RNN to learn from previous inputs and incorporate that information into the current processing.

In some embodiments, the computing system may utilize another type of artificial intelligence model, such as a large language model (LLM). A large language model is a machine learning model designed for natural language processing operations and is trained using self-supervised learning on a relatively large amount of text. In at least some embodiments, a large language model that may be utilized by the computing system is a generative pretrained transformer that may be fine-tuned through prompt engineering. A generative pre-trained transformer (GPT) is a type of generative artificial intelligence framework based on a transformer deep learning architecture that is pre-trained on a relatively large data set of unlabeled text to produce human-like outputs. In a transformer architecture, text is converted into a vector structure through a word embedding table, and in each of multiple layers of the architecture, the transformer contextualizes the token within the scope of a context window with other tokens through a parallel multi-head attention mechanism. Through the architecture, a signal for a key (e.g., significant) token may be amplified and the signal for less significant token may be de-emphasized. Among other benefits, the transformer architecture enables shorter training times compared to the training times of RNN's for similar tasks.

An artificial intelligence model, such as an RNN or an LLM, may be trained to output a markup language, such as HTML and/or CSS, in accordance with a format associated with a corresponding voting machine poll tape. Accordingly, by utilizing a corresponding artificial intelligence model, the computing system may adaptively simulate the formats of many different voting machines, without requiring a template to be defined for each different voting machine.

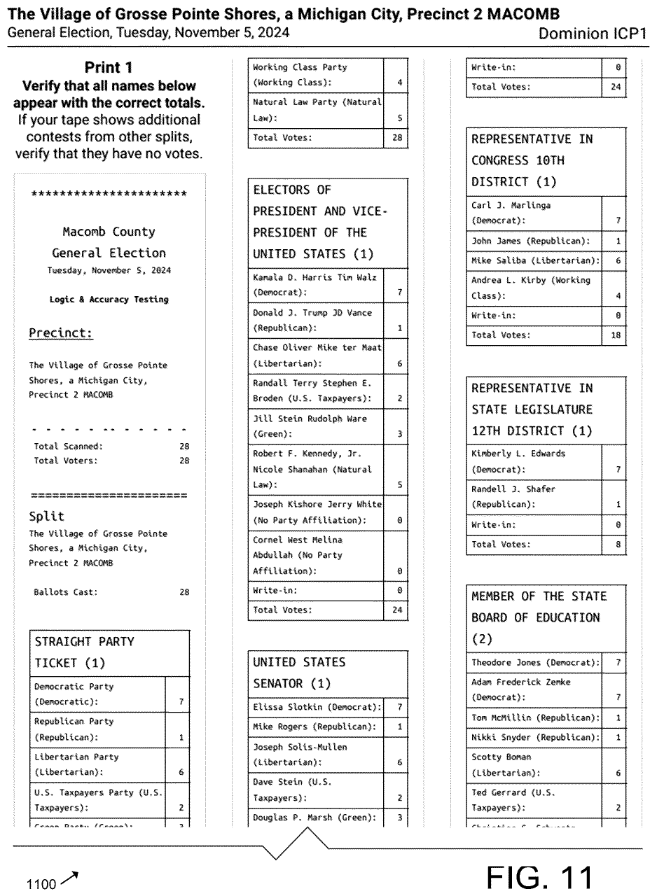

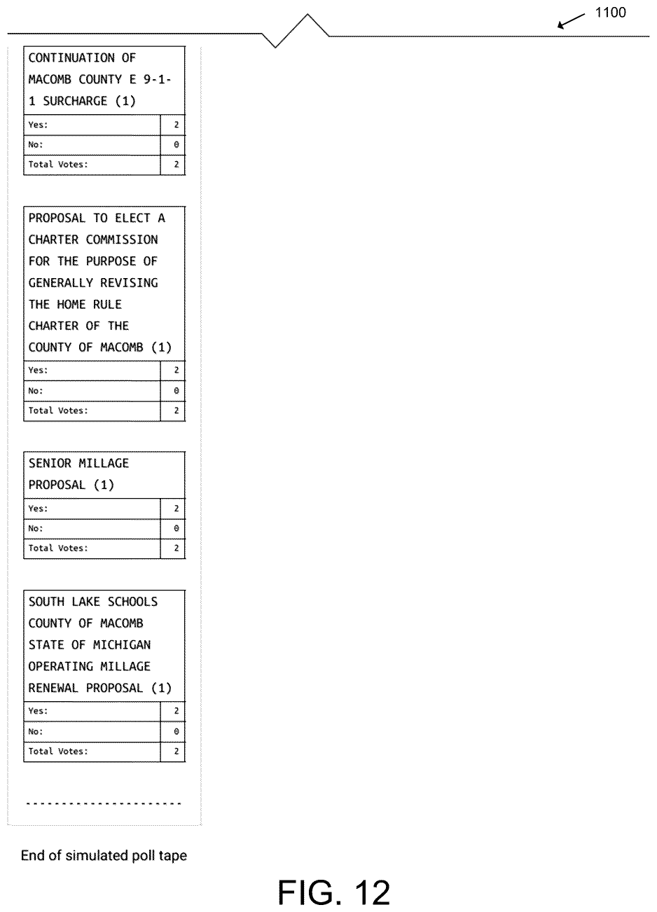

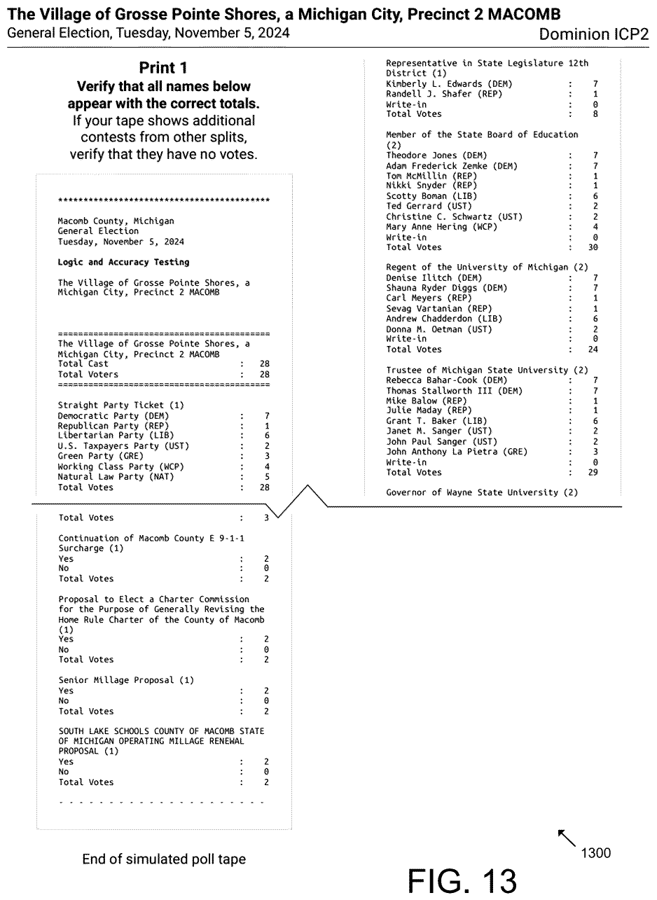

The computing system, in the illustrative embodiment, provides the rendered simulated poll tape to a user computing device 140, 142 to facilitate verification of the corresponding physical voting machine 150, 152, as indicated in block 432. That is, by providing the simulated poll tape to a user computing device 140, 142, a corresponding user may view simulated poll tape and compare the simulated poll tape to a corresponding physical poll tape produced by the corresponding voting machine 150, 152 based on analyzing the same test deck(s) of test ballots as those analyzed by the computing system in block 378 of the method 300. Partial views of a simulated poll tape 1100 that may be produced by the computing system, having a style associated with one type of voting machine 150, 152 are shown in FIGS. 11 and 12. Partial views of another simulated poll tape 1300 that may be produced by the computing system, having a style associated with another type of voting machine 150, 152, are shown in FIG. 13. Given that each simulated poll tape 1100, 1300 matches the formatting of the physical poll tape produced by the actual, physical version of the corresponding voting machine 150, 152, any differences between the simulated poll tape and the poll tape produced by the physical voting machine 150, 152 would be immediately apparent and would be attributable to an error in the operation of the physical voting machine 150, 152 rather than a difference in formatting. Accordingly, the system 100, by performing the method 300, vastly increases the reliability and speed with which the operations of the voting machine 150, 152 may be tested, as compared to conventional systems and methods.

What is claimed is:

1. A method for producing a simulated poll tape for efficient verification of operation of a voting machine, comprising:
obtaining, by a voting machine simulation device, sample ballot data indicative of an image of a ballot to be utilized in an election;
determining, by the voting machine simulation device, a style of the ballot based on the sample ballot data, including identifying sections of the ballot, contests represented in the ballot, and candidates in each contest, and determining voting machine indicia data as a function of visual characteristics of the ballot, including one or more of a shape of a voting target on the ballot and a location of a timing mark on the ballot, wherein the voting machine indicia data is indicative of a corresponding voting machine to be used with the ballot;
identifying, by the voting machine simulation device, a corresponding voting machine as a function of the determined voting machine indicia data, including identifying a corresponding format of a poll tape produced by the corresponding voting machine;
generating, by the voting machine simulation device, a test deck that includes a set of test ballots to be scanned by the identified voting machine;
simulating, by the voting machine simulation device, operation of the identified voting machine to analyze votes represented in the generated test deck; and
producing, by the voting machine simulation device, a simulated poll tape as a function of the simulated operation of the identified voting machine on the generated test deck, wherein the simulated poll tape has an appearance of a poll tape produced by a physical version of the identified voting machine and enables efficient visual comparison to determine whether operation of the physical version of the identified voting machine has not been compromised.

2. The method of claim 1, wherein obtaining sample ballot data comprises obtaining sample ballot data that is indicative of images of multiple ballots to be used in corresponding districts, wherein each ballot has a different style, and determining the style comprises determining the corresponding style of each of the multiple ballots.

3. The method of claim 1, further comprising:
determining a structure of the obtained sample ballot data based on non-image data embedded in the sample ballot data, including determining one or more tags indicative of one or more corresponding properties of elements to be rendered in the corresponding ballot and identifying the sections of the ballot as a function of one or more of font sizes, line widths, or shading represented in the ballot; and
storing data indicative of the structure and properties of the ballot in a JavaScript Object Notation format.

4. The method of claim 1, wherein determining the voting machine indicia data as a function of visual characteristics of the ballot further comprises determining the voting machine indicia as a function of an ellipticity of each of multiple voting targets of the ballot, and wherein identifying the corresponding voting machine as a function of the determined voting machine indicia data comprises determining a corresponding manufacturer and model of the voting machine by comparing the voting machine indicia data to reference data that associates voting machine indicia to a set of voting machine manufacturers and models, and determining a corresponding format the poll tape produced by the determined manufacturer and model of the voting machine comprises selecting a corresponding poll tape template associated with the determined manufacturer and model.

5. The method of claim 1, wherein the sample ballot data represents multiple ballots and determining the stye comprises determining a corresponding style for each of the multiple ballots, and wherein generating the test deck comprises:
generating the test deck as a function of each determined style, including placing markings at two-dimensional coordinates on the test ballots as a function of the determined structure and properties associated with the corresponding style;
selectively adding stray marks to one or more of the test ballots as a function of applicable local rules for testing voting machines;
selectively populating one or more write-in sections as a function of the local rules for testing voting machines; and
applying an optimization to minimize a number of test ballots in the test deck while enabling testing for a defined set of potential errors.

6. The method of claim 5, further comprising producing a test chart indicative of a plan for a test of the corresponding voting machine.

7. The method of claim 1, wherein simulating operation of the identified voting machine to analyze the votes represented in the generated test deck comprises:
identifying marks on each test ballot in the test deck;
attributing the marks to the corresponding candidates for each contest as a function of the determined style;
selectively applying straight party voting rules in response to a determination that a straight party option is marked on one or more of the test ballots;
determining whether a contest is overvoted as a function of a maximum number of votes allowed and a number of votes counted on the test ballots and selectively recording an overvote condition in response to a determination that a contest is overvoted;
determining a presence of an undervote condition indicative of fewer than an allowed number of votes for a contest and selectively recording an undervote condition in response to a determination that a contest is undervoted;
tracking a number of write-ins represented in the test deck;
tracking names that appear in each write-in section in the test deck;
selectively applying de-rotation to account for rotation in an order of candidate names;
selectively tracking subtotals associated with one or more parts of a test; and
determining a grand total of votes represented in the test deck.

8. The method of claim 1, wherein producing the simulated poll tape comprises producing a simulated poll tape that is formatted according to a template associated with the identified voting machine and indicating, in the poll tape, totals of votes associated with the contests represented in the ballot, and one or more of a presence of an overvote condition, a presence of an undervote condition, a write-in, or one or more subtotals.

9. The method of claim 8, wherein the sample ballot data is indicative of multiple ballots having different styles, the method further comprising determining the corresponding style of each of the multiple ballots and producing the simulated poll tape for each of multiple determined styles of ballots.

10. The method of claim 8, wherein the template includes hyper text markup language and cascading style sheets, the method further comprising rendering the simulated poll tape with a web browser rendering engine.

11. The method of claim 10, further comprising providing the rendered simulated poll tape to a user computing device to facilitate verification of operation of the physical version of the identified voting machine.

12. The method of claim 11, further comprising converting the rendered simulated poll tape to a portable document format.

13. A computing system for producing a simulated poll tape for efficient verification of operation of a voting machine, the computing system comprising:
at least one processor; and
at least one memory comprising a plurality of instructions stored thereon that, in response to execution by the at least one processor, causes the computing system to:
obtain sample ballot data indicative of an image of a ballot to be utilized in an election;
determine a style of the ballot based on the sample ballot data, including identifying sections of the ballot, contests represented in the ballot, and candidates in each contest, and determining voting machine indicia data as a function of visual characteristics of the ballot, including one or more of a shape of a voting target on the ballot and a location of a timing mark on the ballot, wherein the voting machine indicia data is indicative of a corresponding voting machine to be used with the ballot;
identify a corresponding voting machine as a function of the determined voting machine indicia data, including identifying a corresponding format of a poll tape produced by the corresponding voting machine;
generate a test deck that includes a set of test ballots to be scanned by the identified voting machine;
simulate operation of the identified voting machine to analyze votes represented in the generated test deck; and
produce a simulated poll tape as a function of the simulated operation of the identified voting machine on the generated test deck, wherein the simulated poll tape has an appearance of a poll tape produced by a physical version of the identified voting machine and enables efficient visual comparison to determine whether operation of the physical version of the identified voting machine has not been compromised.

14. The computing system of claim 13, wherein the processor is further configured to:
obtain sample ballot data that is indicative of images of multiple ballots to be used in corresponding districts, wherein each ballot has a different style, and determining the style comprises determining the corresponding style of each of the multiple ballots.

15. The computing system of claim 13, wherein the processor is further configured to:
determine a structure of the obtained sample ballot data based on non-image data embedded in the sample ballot data, including determining one or more tags indicative of one or more corresponding properties of elements to be rendered in the corresponding ballot and identifying the sections of the ballot as a function of one or more of font sizes, line widths, or shading represented in the ballot; and
store data indicative of the structure and properties of the ballot in a JavaScript Object Notation format.

16. The computing system of claim 13, wherein the processor is further configured to:
determine the voting machine indicia as a function of an ellipticity of each of multiple voting targets of the ballot;
determine a corresponding manufacturer and model of the voting machine by comparing the voting machine indicia data to reference data that associates voting machine indicia to a set of voting machine manufacturers and models; and
select a corresponding poll tape template associated with the determined manufacturer and model.

17. The computing system of claim 13, wherein the sample ballot data represents multiple ballots and the processor is further configured to:
determine a corresponding style for each of the multiple ballots;
generate the test deck as a function of each determined style, including placing markings at two-dimensional coordinates on the test ballots as a function of the determined structure and properties associated with the corresponding style;
selectively add stray marks to one or more of the test ballots as a function of applicable local rules for testing voting machines;
selectively populate one or more write-in sections as a function of the local rules for testing voting machines; and
apply an optimization to minimize a number of test ballots in the test deck while enabling testing for a defined set of potential errors.

18. The computing system of claim 17, wherein the processor is further configured to:
produce a test chart indicative of a plan for a test of the corresponding voting machine.

19. The computing system of claim 13, wherein the processor is further configured to:
identify marks on each test ballot in the test deck;
attribute the marks to the corresponding candidates for each contest as a function of the determined style;
selectively apply straight party voting rules in response to a determination that a straight party option is marked on one or more of the test ballots;
determine whether a contest is overvoted as a function of a maximum number of votes allowed and a number of votes counted on the test ballots and selectively recording an overvote condition in response to a determination that a contest is overvoted;
determine a presence of an undervote condition indicative of fewer than an allowed number of votes for a contest and selectively recording an undervote condition in response to a determination that a contest is undervoted;
track a number of write-ins represented in the test deck;
track names that appear in each write-in section in the test deck;
selectively apply de-rotation to account for rotation in an order of candidate names;
selectively track subtotals associated with one or more parts of a test; and
determine a grand total of votes represented in the test deck.

20. The computing system of claim 13, wherein the processor is further configured to:
produce a simulated poll tape that is formatted according to a template associated with the identified voting machine and indicates, in the poll tape, totals of votes associated with the contests represented in the ballot, and one or more of a presence of an overvote condition, a presence of an undervote condition, a write-in, or one or more subtotals;
wherein the sample ballot data is indicative of multiple ballots having different styles and the template includes hyper text markup language and cascading style sheets, and the processor is further configured to:
determine the corresponding style of each of the multiple ballots;
produce the simulated poll tape for each of multiple determined styles of ballots;
render the simulated poll tape with a web browser rendering engine;
convert the rendered simulated poll tape to a portable document format; and
provide the rendered simulated poll tape to a user computing device to facilitate verification of operation of the physical version of the identified voting machine.

21. A method for producing a simulated poll tape for efficient verification of operation of a voting machine, comprising:
obtaining, by a voting machine simulation device, sample ballot data indicative of an image of a ballot to be utilized in an election or a description of a style of the ballot in a machine readable data format;
identifying, by the voting machine simulation device, a corresponding voting machine as a function of the sample ballot data, including identifying a corresponding format of a poll tape produced by the corresponding voting machine;
simulating, by the voting machine simulation device, operation of the voting machine to produce, based on a set of votes represented in a test deck or a test chart, a simulated poll tape, wherein the simulated poll tape has an appearance of a poll tape produced by a physical version of the identified voting machine and enables efficient visual comparison to determine whether operation of the physical version of the identified voting machine has not been compromised.

22. A computing system for producing a simulated poll tape for efficient verification of operation of a voting machine, the computing system comprising:
at least one processor; and
at least one memory comprising a plurality of instructions stored thereon that, in response to execution by the at least one processor, causes the computing system to:
obtain sample ballot data indicative of an image of a ballot to be utilized in an election or a description of a style of the ballot in a machine readable data format;
identify a corresponding voting machine as a function of the sample ballot data, including identifying a corresponding format of a poll tape produced by the corresponding voting machine;
simulate operation of the voting machine to produce, based on a set of votes represented in a test deck or a test chart, a simulated poll tape, wherein the simulated poll tape has an appearance of a poll tape produced by a physical version of the identified voting machine and enables efficient visual comparison to determine whether operation of the physical version of the identified voting machine has not been compromised.
